(19) United States
(12) Patent Application Publication
(10) Pub. No.: US 2025/0342451 A1
(43) Pub. Date: Nov. 6, 2025

(54) SYSTEMS AND METHODS FOR GENERATING, INTEGRATING AND ENHANCING DATA FROM A PLURALITY OF SOURCES USING A SINGLE PLATFORM

(71) Applicant: Ahmed Farouk SHAABAN, Hoffman Estates, IL (US)

(72) Inventors: Ahmed Farouk SHAABAN, South Barrington, IL (US); Venkat THANDRA, South Barrington, IL (US); Dino George ELIOPULOS, Lakewood, IL (US)

(21) Appl. No.: 19/198,821

(22) Filed: May 5, 2025

Related U.S. Application Data
(60) Provisional application No. 63/642,968, filed on May 6, 2024.
(60) Provisional application No. 63/681,740, filed on Aug. 9, 2024.

(51) Int. Cl. G06Q 20/02; G06F 9/54; G06Q 20/38

(52) U.S. Cl. CPC G06Q 20/027; G06F 9/547; G06Q 20/389

(57) ABSTRACT

Systems and methods linking a first party with a plurality of second parties via a single platform executing multiple applications are disclosed herein. In an embodiment, the system includes a memory storing a second party database, a processor programmed to cause generation of a graphical user interface prioritizing data from the second party database and enabling the first party to select a second party as a service provider, and an application programming interface configured to define how the processor communicates with a plurality of external sources via a routing gateway. The processor is programmed to communicate with the external sources via the routing gateway for generation of the graphical user interface, and to communicate with a third-party payment gateway via the application programming interface to cause a common application section of the graphical user interface to accept payment from the selected service provider using the third-party payment gateway.

### RELATED APPLICATION

This application claims priority to U.S. Provisional Patent Application No. 63/642,968, filed May 6, 2024 and entitled “Systems and Methods for Managing Work,” and to U.S. Provisional Patent Application No. 63/681,740, filed Aug. 9, 2024 and entitled “Systems and Methods for Generating, Integrating and Enhancing Data from a Plurality of Sources using a Single Platform,” the entire contents of each of which are incorporated herein by reference and relied upon.

### BACKGROUND

### Technical Field

This disclosure generally relates to systems and methods for generating, integrating and enhancing data from a plurality of external sources using a single platform. More specifically, this disclosure relates to optimized systems and methods for operating a single platform that runs multiple applications using limited computer processing and memory storage resources.

### Background Information

Many companies obtain new business by providing current or potential clients with bids or quotes for one or more services to be performed. This can be time consuming and speculative for companies that bill by the hour for a variety of workers with different billing rates, such as consulting firms, law firms, accounting firms, etc. This process can also generate large amounts of data relating to services and/or external parties even before work begins, with the parties involved then needing separate platforms for work performance, invoicing and payment. This process using multiple platforms consumes significant processing resources and results in data storage redundancies, particularly as the number of parties involved increases.

### SUMMARY

The systems and methods of the present disclosure improve upon prior art systems that use multiple platforms with incompatible data by providing a single full-service platform that increases reliability of quotes for work, optimizes processing resources when generating the quotes and invoicing resulting services, conserves memory space by eliminating data redundancies, and improves user experience on both the client side and the service provider side. On both the client side and the service provider side, the systems and methods of the present disclosure also enable users a range of capabilities without the users having to navigate through and open separate applications to achieve full functionality.

In an embodiment, the systems and methods of the present disclosure provide artificial intelligence (AI) powered training methods to match clients and service providers based on their specific needs, expertise, location, and user preferences.

In an embodiment, the systems and methods of the present disclosure provide an intelligent proposal evaluation engine that automatically evaluates and scores proposal submissions based on predefined criteria, saving time and effort in any bid selection process.

In an embodiment, the systems and methods of the present disclosure provide dynamic real-time bidding and auction functionality that allows service providers to bid on projects to create competitive pricing and efficient selection of the service providers for the projects.

In an embodiment, the systems and methods of the present disclosure provide interactive contract negotiation using a single platform to facilitate real-time collaboration between clients and service providers, with features such as live document editing, commenting, and instant messaging.

In an embodiment, the systems and methods of the present disclosure provide blockchain-powered secure payment and invoicing which ensures secure and transparent payment processing and invoicing using a single platform, enhancing trust and reducing fraud risks in financial transactions.

In an embodiment, the systems and methods of the present disclosure provide advanced work-in-progress (WIP) tracking and reporting that captures and analyzes detailed information about the progress, time spent, and costs associated with ongoing matters, enabling accurate reporting and forecasting.

In an embodiment, the systems and methods of the present disclosure provide intelligent matter management and progress tracking, milestone management, and task assignment to ensure efficient collaboration and timely completion of matters.

In an embodiment, the systems and methods of the present disclosure provide an integrated dispute resolution and customer support center to submit disputes, track progress, and receive prompt assistance.

In an embodiment, the systems and methods of the present disclosure provide secure document collaboration and redlining which allows multiple parties to collaborate on legal documents, track changes, and perform redlining to ensure seamless collaboration and version control.

In an embodiment, the systems and methods of the present disclosure provide advanced analytics and performance reporting with actionable insights, performance reports, and data-driven recommendations for optimizing legal operations and decision-making.

One aspect of the present disclosure is to provide a computer-implemented system linking a first party with a plurality of second parties via a single platform configured to execute multiple applications. The system comprises at least one memory storing a second party database including information about the plurality of second parties, at least one processor programmed to cause generation of a graphical user interface prioritizing data from the second party database based on at least one selection made by the first party and to enable the first party to select at least one of the second parties as a service provider using the graphical user interface, and an application programming interface configured to define how the at least one processor communicates with a plurality of external sources via a routing gateway. The at least one processor is programmed to communicate with the plurality of external sources via the routing gateway for generation of the graphical user interface, and to communicate with a third-party payment gateway via the application programming interface to cause a common application section of the graphical user interface to accept payment from the selected service provider using the third-party payment gateway.

Another aspect of the present disclosure is to provide a computer-implemented method of training a neural network to retrieve bids for a service from a plurality of external service providers. The method comprises collecting data relating to a plurality of bids for a service to be performed by one or more of the plurality of external service providers, retrieving data from one or more public data sources for each of the plurality of external service providers, receiving a selection of at least one of the plurality of bids for the service as an accepted bid, creating a first training set comprising data regarding the accepted bid and the data from the public data source for the external service provider corresponding to the accepted bid, training the neural network in a first stage using the first training set, creating a second training set comprising data regarding others of the plurality of bids for the service and the data from the public source for the external service providers corresponding to the others of the plurality of bids, and training the neural network in a second stage using the second training set.

Another aspect of the present disclosure is to provide a computer-implemented method of enabling functional applications via a user interface. The method comprises providing a user with a graphical user interface having an application bar and a common application section, providing access to at least one first application by the user within the common application section such that the user is enabled to generate parameters for a plurality of service providers to bid on a service, executing the at least one first application to publish the parameters for the plurality of service providers and accept a plurality of bids on the service from at least two of the plurality of service providers, providing access to at least one second application by the user using the common application section such that the user is enabled to partially reject an invoice from one of the plurality of service providers, and executing the at least one second application to make a partial payment to the one of the pluralities of service providers.

In an embodiment, the at least one first application causes retrieved third party data to be combined with local data and generates a graphical illustration illustrating the data in the common application section. In another embodiment, the at least one first application enables the user to adjust filters to identify criteria for the service. In another embodiment, the at least one first application generates a listing to solicit bids for the service. In another embodiment, the at least one first application enables the user to indicate at least one of: (i) a start date for the service; (ii) an end date for the service; (iii) an area of law for the service; (iv) a region of the service; and (v) any adverse parties involved in the service. In another embodiment, the at least one second application includes a payments application that can be executed to perform a full or partial payment of the invoice. In another embodiment, the at least one second application includes a payments application that can be executed to enable multiple parties to pay the invoice. In another embodiment, the at least one second application utilizes a third-party payment gateway operatively connected to an application programming interface to execute the partial payment.

Another aspect of the present disclosure is to provide a computer-implemented method for linking a first party with a plurality of second parties via a single platform configured to execute multiple applications. The method includes accessing at least one memory storing a second party database including information about the plurality of second parties, defining communication between a plurality of external sources via a routing gateway, communicating with the plurality of external sources via the routing gateway for generation of a graphical user interface, causing generation of the graphical user interface prioritizing data from the second party database based on at least one selection made by the first party, enabling the first party to select at least one of the second parties as a service provider using the graphical user interface, and communicating with a third-party payment gateway via an application programming interface to cause a common application section of the graphical user interface to accept payment from the selected service provider using a third-party payment gateway.

Another aspect of the present disclosure is to provide another computer-implemented method for linking a first party with a plurality of second parties via a single platform configured to execute multiple applications. The method includes enabling the first party to invite the plurality of second parties to bid on a matter, causing generation of one or more useable icons on second graphical user interfaces of second user terminals used by the plurality of second parties, accessing at least one memory storing a second party database including information about the plurality of second parties which accepted the invitation to bid, generating a first graphical user interface on a first user terminal used by the first party which prioritizes data from the second party database based on at least one selection made by the first party, enabling the first party to select at least one of the second parties as a service provider using the first graphical user interface prioritizing the data from the second party database, and enabling the first party to pay a selected service provider for an invoice for the matter via the first graphical user interface using a third-party payment gateway.

Another aspect of the present disclosure is to provide a computer-implemented method of training a neural network to retrieve bids for a service from a plurality of external service providers. The method includes collecting data relating to a plurality of bids for a service to be performed by one or more of the plurality of external service providers, receiving a selection of at least one of the plurality of bids for the service as an accepted bid, creating a first training set comprising data regarding the accepted bid, training the neural network in a first stage using the first training set, creating a second training set comprising data regarding others of the plurality of bids for the service that were not accepted, training the neural network in a second stage using the second training set, training the neural network to generate an external service provider profile that can then be customized by at least one external service provider.

Another aspect of the present disclosure is to provide another computer-implemented method of training a neural network to retrieve bids for a service for a first party from a plurality of second party external service providers. The method includes retrieving data from a plurality of bid responses for the service from the plurality of second party external service providers, deriving feature vectors from the data from the plurality of bid responses for the service, generating a first training set and a second training set using the feature vectors, training a neural network to learn mappings between first party preferences and second party attributes using the first training set and the second training set, and using the neural network to rank a plurality of subsequent bid responses from the plurality of second party external service providers for a subsequent service for the first party.

Another aspect of the present disclosure is to provide a computer-implemented method of enabling functional applications via a user interface. The method includes receiving a customer selection via a graphical user interface having a static application bar, developing a set of customer parameters based on a customer profile, a set of service parameters, and the customer selection, determining, by a processor, a set of pre-determined customer requirements based on data from a data aggregation and visualization engine, creating a template on the static application bar for a user to update a set of service parameters, matching a plurality of sets of provider information, using an external database to further process the set of customer parameters, executing at least one first application to process a bid, and executing at least one second application to review a bid response.

Another aspect of the present disclosure is to provide another computer-implemented method of enabling functional applications via a user interface. The method includes executing at least one first application to collect bid information from a first party, executing at least one second application to collect bid responses from a plurality of second parties, displaying a graphical user interface including at least one static application bar, using a data aggregation and visualization engine to represent bids on the graphical user interface, adjusting representation of the bids on the graphical user interface using a neural network trained to process feature vectors at least from the bid responses.

Other objects, features, aspects and advantages of the systems and methods disclosed herein will become apparent to those skilled in the art from the following detailed description, which, taken in conjunction with the annexed drawings, discloses exemplary embodiments of the disclosed systems and methods.

### BRIEF DESCRIPTION OF THE DRAWINGS

Referring now to the attached drawings which form a part of this original disclosure:

FIG. 1 illustrates an example embodiment of a system for generating and integrating data from a plurality of external sources using a single platform in accordance with the present disclosure;

FIG. 2 is a representative diagram of an example embodiment of a user terminal which can be used in the system of FIG. 1;

FIG. 3 is a system architecture drawing illustrating an example embodiment of a system for generating and integrating data from a plurality of external sources using a single platform in accordance the present disclosure;

FIGS. 4 to 27 illustrate various exemplary embodiments of graphical user interfaces generated by the system of FIGS. 1 to 3 in accordance with the methods discussed herein;

FIG. 28 illustrates an example embodiment of a method of implementing an ordered series of algorithms to initialize and operate a single platform in accordance with the present disclosure;

FIG. 29 illustrates an example embodiment of a method of training a neural network to retrieve bids for a service from a plurality of external service providers in accordance with the present disclosure; and

FIG. 30 illustrates an example embodiment of a method to retrieve bids for a service from a plurality of external service providers in accordance with the present disclosure.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

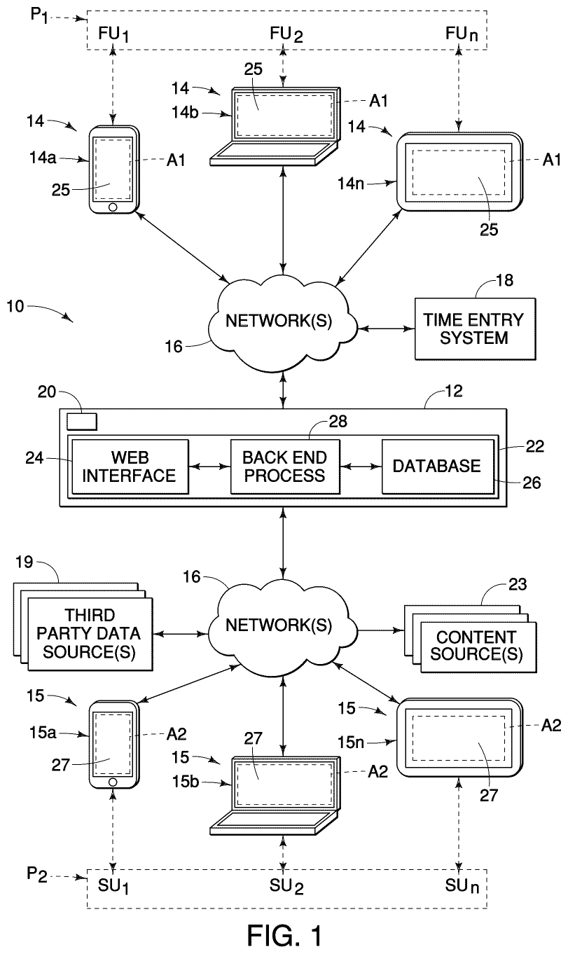

FIG. 1 illustrates an example embodiment of a system 10 for generating and integrating data from a plurality of external sources using a single platform in accordance with the present disclosure. In the illustrated embodiment, the system 10 includes a central server 12, one or more first user terminals 14 operated by one or more first users FU₁, FU₂ . . . FUₙ of a first party P₁, and one or more second user terminals 15 operated by one or more second users SU₁, SU₂ . . . SUₙ of a second party P₂. In use, the central server 12 is configured to wirelessly communicate with each of the user terminals 14, 15 via a network 16. In the illustrated embodiment, the first party P₁ is a client seeking one or more service provider for a project, and the second party P₂ is a service provider seeking to bid on the project.

Each of the plurality of first user terminals 14 can be, for example, a cellular phone, a tablet, a personal computer, a smart watch, or another electronic device. Here, the plurality of first user terminals 14 includes a user terminal 14a, a user terminal 14b, and a user terminal 14n. Each first user terminal 14 can be controlled by a distinct first user FU₁, FU₂ . . . FUₙ of the first party P₁ (e.g., one user FU₁ controls the user terminal 14a, another user FU₂ controls the user terminal 14b, and another user FUₙ controls the user terminal 14n). The first user FU₁, FU₂ . . . FUₙ of each user terminal 14 can be, for example, a member or employee of the first party P₁. As used herein, each of the first users FU₁, FU₂ . . . FUₙ can also be referred to generally as a user U. In an embodiment, the first party P₁ can be any business that contracts service providers using fixed fees or billing rates (e.g., hourly time entries) to bill clients, such service providers including, for example, consulting firms, law firms, accounting firms, or similar businesses.

Each of the plurality of second user terminals 15 can be, for example, a cellular phone, a tablet, a personal computer, a smart watch, or another electronic device. Here, the plurality of second user terminals 15 includes a user terminal 15a, a user terminal 15b, and a user terminal 15n. Each second user terminal 15 can be controlled by a distinct user SU₁, SU₂ . . . SUₙ of the second party P₂ (e.g., one user SU₁ controls the user terminal 15a, another user SU₂ controls the user terminal 15b, and another user SUₙ controls the user terminal 15n). The second user SU₁, SU₂ . . . SUₙ of each user terminal 15 can be, for example, a member or employee of the second party P₂. As used herein, each of the users SU₁, SU₂ . . . SUₙ can also be referred to generally as a user U. In an embodiment, the second party P₂ can be any business that provides a service or product using fixed fees or billing rates (e.g., hourly time entries), such businesses including, for example, consulting firms, law firms, accounting firms, or similar businesses.

Although a single first party P₁ and a single second party P₂ may be discussed herein for simplicity, it should be understood from this disclosure that the system 10 can operate to support any number of such parties and significantly improves processing efficiency and decreases time spent and memory storage needed as the number of users U, first parties P₁ and/or second parties P₂ increases. Further, the system 10 provides a single platform for multiple first parties P₁ and second parties P₂ that are operating using different operating systems.

The system 10 is configured to access various internal and external data sources. As seen in FIG. 1, the system 10 is configured to access a time entry database 18, a third-party database 19, and/or a quote generation database 23. The time entry database 18 can include a database controlled by the first party P₁ or the second party P₂ using the system 10, for example, an existing time entry database 18 which is used by each of the users U of the first party P₁ or the second party P₂ to record time entries which are then used for billing purposes. In an embodiment, the time entry database 18 includes the time entry database described in U.S. application Ser. No. 17/718,019, entitled “Systems and Methods for Time Entry, Management and Billing,” the entire contents of which is incorporated herein by reference. The third-party database 19 can include a database which is controlled by a third party besides the first party P₁ or the second party P₂, which is accessed by the central server 12 via the network 16, for example, a website controlled by the third party. In an embodiment, the third-party database 19 is accessible by the system 10 via a public website. The quote generation database 23 can include a database controlled by the first party P₁ or the second party P₂ using the system 10, for example, an existing quote generation database 23 which is used by users U of the first party P₁ or the second party P₂ to generate quotes outside of the single platform disclosed herein. In an embodiment, the quote generation database includes the quote generation database described in U.S. application Ser. No. 17/718,041, entitled “Systems and Methods for Efficiently Generating Reliable Client Billing Quotes,” the entire contents of which is incorporated herein by reference.

The user terminals 14, 15 can communicate with the central server 12 via various communication protocols, for example, via an Internet Protocol Suite or TCP/IP supporting HTTP. The network 16 can comprise a public network (e.g., the Internet, World Wide Web, etc.), a private network (e.g., local area network (LAN), etc.), and/or combinations thereof (e.g., a virtual private network, LAN connected to the Internet, etc.). The network 16 can include a wired network, a wireless network, and/or a combination of the two.

The central server 12 can comprise one or more server computers, database servers and/or other types of computing devices, particularly in connection with, for example, the implementation of websites and/or enterprise software. The central server 12 can further comprise a central processor 20 and a central memory 22. The central processor 20 is configured to execute instructions programmed into and/or stored by the central memory 22. In an embodiment, the central processor 20 can comprise one or more of a microprocessor, microcontroller, digital signal processor, co-processor or the like or combinations thereof capable of executing stored instructions and operating upon stored data, wherein the instructions and/or data are stored by the central memory 22. The central memory 22 can comprise one or more devices such as volatile or nonvolatile memory, for example, random access memory (RAM) or read only memory (ROM). Further, the central memory 22 can be embodied in a variety of forms, such as a hard drive, optical disc drive, floppy disc drive, etc. In an embodiment, the steps of the methods described herein are stored as instructions in the central memory 22 and executed by the central processor 20.

In the illustrated embodiment, the central memory 22 includes a web interface 24, a central database 26, and back-end processing instructions 28. Here, the web interface 24, the central database 26, and the back-end processing instructions 28 can be controlled or accessed by the central processor 20 implementing appropriate software programs by executing the back-end processing instructions 28 or other instructions programmed into and/or stored by the central memory 22.

The web interface 24 is configured to provide a graphical user interface (“GUI”) 25 that can be displayed on a first user terminal 14 for a first user FU of a first party P₁, and is configured to manage the transfer of data received from and sent to the GUI 25 on the first user terminal 14. For example, the GUI 25 can be employed by a first user FU to provide input data to the central server 12 for the generation of a quote by a second party P₂, to edit documents such as contracts with the second party P₂, to review and fully or partially contest invoices provided by the second party P₂, and to fully or partially pay the invoices provided by the second party P₂. In an embodiment, each first user terminal 14 includes an application A1 comprising software downloaded to and executed by the first user terminal 14 to provide the GUI 25 and to manage communications with the central server 12. The application A1 can be downloaded to the first user terminal 14 from the central server 12 or from some other source such as an application distribution platform. A user U can then access all of the functionality of the applications discussed herein by opening the application A1. In an embodiment, the application A1 can also be viewed via a web browser.

The web interface 24 is also configured to provide a GUI 27 that can be displayed on a second user terminal 15 for a second user SU of a second party P₂, and is configured to manage the transfer of data received from and sent to the GUI 27 on the second user terminal 15. For example, the GUI 27 can be employed by a second user SU to provide input data to the central server 12 for the generation of a quote for a first party P₁, to edit documents such as contracts with the first party P₁, to receive data regarding fully or partially contested invoices from by the first party P₁, and to receive payment for fully or partially paid invoices from the first party P₁. In an embodiment, each second user terminal 15 includes an application A2 comprising software downloaded to and executed by the second user terminal 15 to provide the GUI 27 and to manage communications with the central server 12. The application A2 can be downloaded to the second user terminal 15 from the central server 12 or from some other source such as an application distribution platform. A user U can then access all of the functionality of the applications discussed herein by opening the application A2. In an embodiment, the application A2 can also be viewed via a web browser. In an embodiment, both the first users FU and the second users SU download the same application, and the application provides the first GUI 25 to the first users FU of the first party P₁ and provides a different second GUI 27 to the second users SU of the second party P₂.

The central database 26 is configured to effectively store various types of generated and enhanced data as further discussed herein. The data can include input data, team data, quote data, invoice data, accounting or payment data and/or other data discussed herein. The central database 26 is also configured to store data relevant to the first party P₁, the second party P₂, the time entry database 18, the third-party database 19 and the quote generation database 23. In an embodiment, the central database 26 comprises a database management system (DBMS) operating on one or more suitable database server computers. The central database 26 can also comprise storage components from other systems, such as a time entry database 18 having relevant data already stored therein. The central database 26 can be further configured to store editable rules regarding generation of each respective GUI 25 for one or more user terminal 14.

The back-end processing instructions 28 can be operatively coupled to both the web interface 24 and the central database 26, and can be programmed into and/or stored by the central memory 22 and implemented by the central processor 20. In an embodiment, the back-end processing instructions 28 can be executed by the central processor 20 to direct operations of the central server 12 as described below in further detail. For example, the central processor 20, executing the back-end processing instructions 28, can manage the receipt, storage, enhancement, maintenance, etc. of relevant data (e.g., input data, team data, quote data, invoice data, accounting or payment data and/or other data received from one or more first user FU of the first party P₁ via a user terminal 14 or from one or more second user SU of the second party P₂ via a user terminal 15). Additionally, the central processor 20, executing the back-end processing instructions 28, can develop and enhance similar relevant data based on information obtained from the second party P₂, a time entry database 18, a third-party database 19, and/or a quote generation database 23, as well as further functionality as discussed in more detail below.

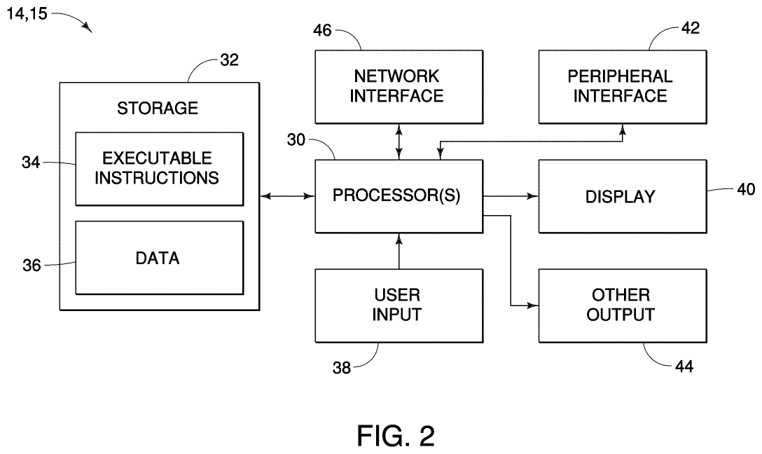

FIG. 2 illustrates a representative diagram of an example embodiment of a user terminal 14, 15. As illustrated, a user terminal 14, 15 can include a terminal processor 30 and a terminal memory 32. The terminal processor 30 is configured to execute instructions programmed into and/or stored by the terminal memory 32. The instructions can be received from and/or periodically updated by the web interface 24 of the central server 12 in accordance with the methods discussed herein. In an embodiment, the methods described herein are stored as instructions in the terminal memory 32 and executed by the terminal processor 30.

In an embodiment, the terminal processor 30 can comprise one or more of a microprocessor, microcontroller, digital signal processor, co-processor or the like or combinations thereof capable of executing stored instructions 34 and operating upon stored data 36, wherein the instructions 34 and/or stored data 36 are stored by the terminal memory 32. The terminal memory 32 can comprise one or more devices such as volatile or nonvolatile memory, for example, random access memory (RAM) or read only memory (ROM). Further, the terminal memory 32 can be embodied in a variety of forms, such as a hard drive, optical disc drive, floppy disc drive, etc. In an embodiment, many of the processing techniques described herein are implemented as a combination of executable instructions 34 and data 36 stored within the terminal memory 32.

As illustrated, each of the plurality of user terminals 14, 15 includes one or more user input device 38, a display 40, a peripheral interface 42, one or more other output device 44, and a network interface 46 in communication with the terminal processor 30. The user input device 38 can include any mechanism for providing a user input to the terminal processor 30, for example, a keyboard, a mouse, a touch screen, a microphone and/or suitable voice recognition application, or another input mechanism. The display 40 can include any conventional display mechanism such as a cathode ray tube (CRT), a flat panel display, a touch screen, or another display mechanism. Thus, as can be understood, the user input device 38 and/or the display 40 and/or any other suitable element can be considered a GUI 25, 27. The peripheral interface 42 can include the hardware, firmware, and/or other software necessary for communication with various peripheral devices, such as media drives (e.g., magnetic disk or optical disk drives), other processing devices, or another input source used as described herein. Likewise, the other output device 44 can optionally include similar media drive mechanisms, other processing devices or other output destinations capable of providing information to a user of the user terminal 14, 15, such as speakers, LEDs, tactile outputs, etc. The network interface 46 can comprise hardware, firmware and/or software that allows the terminal processor 30 to communicate with other devices via wired or wireless networks 16, whether local or wide area, private or public. For example, such networks 16 can include the World Wide Web or Internet, or private enterprise networks, or the like.

While the user terminal 14, 15 has been described as one form for implementing the techniques described herein, those having ordinary skill in the art will appreciate from this disclosure that other functionally equivalent techniques can be employed. For example, some or all of the functionality implemented via executable instructions can also be implemented using firmware and/or hardware devices such as application specific integrated circuits (ASICs), programmable logic arrays, state machines, etc. Further, other implementations of the user terminal 14, 15 can include a greater or lesser numbers of components than those illustrated. Further still, although a single user terminal 14, 15 is illustrated in FIG. 2, it should be understood from this disclosure that a combination of such devices can be configured to operate in conjunction (for example, using known networking techniques) to implement the methods described herein.

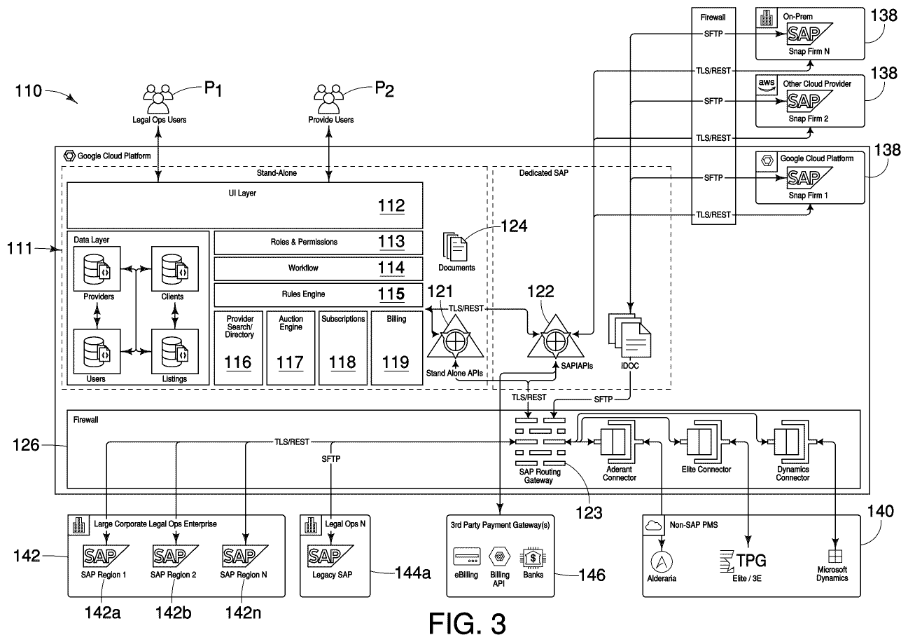

FIG. 3 illustrates system architecture for a system 110 that is an example embodiment of the system 10 for generating, integrating and enhancing data from a plurality of external sources using a single platform 111. In the illustrated embodiment, the system 110 enables a first party P₁ seeking hourly or fixed fee services from a plurality of external second parties P₂ to transact business with and manage matters submitted by the plurality of external second parties P₂. The external second parties P₂ can be, for example, companies that provide hourly or fixed fee services such as law firms, accounting firms, consulting firms, or other service providers. As seen in FIG. 3, the system 110 provides a single platform 111 through which a first party P₁ and a plurality of external second parties P₂ can seamlessly interact via multiple applications and collaborate from matter intake, through contract negotiation, and further through billing and full or partial payment of fees.

The system 110 enables the first party P₁ to run sourcing events through a digitized, standardized and qualitative/quantitatively enabled solution whether directly selecting and running a sourcing event (e.g., Request for Information or “RFI”/Request for Proposal or “RFP”) that is tailored to a select set of panel vendors, or with an open bid process for any second party P₂ on the network 16, or transacting in new ways with panel firms for “bundled” subscriptions, and more. The system 110 enables management of vendors, matters, timekeepers, budgets and matter statuses all on one seamlessly integrated platform 111. The system 110 further enables accelerated review, approval and secured payment of invoices. The system 110 effectively connects second parties P₂ (e.g., service providers) and first parties P₁ (e.g., clients) that may be operating with different kinds of operating systems without the need for one or more intermediaries (ebilling systems), fees, and more.

In the illustrated embodiment, the single platform 111 is a cloud platform. The platform 111 stores a user interface layer 112 which controls the GUI 25 used by a first party P₁ and the GUI 27 used by the second party P₂, a rules and permissions database 113 which defines the information available to a first party P₁ or a second party P₂ via the respective GUI 25, 27, a workflow database 114 which defines a series of steps performed to enhance data from external sources to achieve the GUI 25, 27, and a rules engine 115 which uses the central processor 20 to execute applications in accordance with one or more rules set for a first party P₁ or a second party P₂. The platform 111 also includes a second party database 116 that stores data regarding the second parties P₂ which has been provided by the second parties P₂ and/or retrieved from a public data source such as a time entry database 18, a third-party database 19 or a quote generation database 23, an auction engine 117 which permits a plurality of second parties P₂ to bid on a service needed by the first party P₁, a subscription database 118 that stores different combinations of hourly and fixed fee services provided by one or more second party P₂, and a billing database 119 which stores records of invoices and payments made using the platform 111. The single platform 111 further includes a standalone application programming interface 121. As seen in FIG. 3, the standalone application programming interface 121 is operatively connected to a dedicated application programming interface 122. As also seen in FIG. 3, a firewall 126 is implemented for certain of the external data sources.

In the illustrated embodiment, the standalone application programming interface 121 and the dedicated application programming interface 122 are both operatively connected to a routing gateway 123. The routing gateway 123 operatively connects each of the SAP S/4 HANA clients 138 and non-SAP clients 140 to the standalone application programming interface 121 and the dedicated application programming interface 122, while the third-party payment gateway/platforms 146 bypass the routing gateway 123 to the dedicated application programming interface 122. The central processor 20 is programmed to communicate with the illustrated external sources via the routing gateway 123 for generation of the GUI 25, 27, and to communicate with a third-party payment platform 146 via the dedicated application programming interface 122 to cause a common application section 151 of the GUI 25, 27 to accept payment from the selected service provider using the third-party payment platform 146. By structuring the system 110 as shown in FIG. 3, minimal processing resources and memory space are needed to run the single platform 111 including all of the applications discussed herein for multiple first parties P₁ and second parties P₂.

As seen in FIG. 3, the system 110 includes a document database 124. More specifically, the platform 111 includes the document database 124. The document database 124 is configured to store documents that can be edited by both first and second parties P₁, P₂ using an application generated within the GUI 25, 27. By storing the documents and enabling editing in this way, the system 110 minimizes processing power and data storage needed to send drafts back and forth between the first and second parties P₁, P₂ and eliminates errors from drafts crossing paths. In an embodiment, the central processor 20 enables both the first party P₁ and the second party P₂ (e.g., the selected service provider) to edit at least one document in the document database 124 via a common application section 151 of the GUI 25, 27. In an embodiment, the system 110 further enables secure document collaboration and redlining by executing a document collaboration workspace allowing multiple parties to collaborate on legal documents, track changes, and perform redlining to ensure seamless collaboration and version control.

In an embodiment, the system 110 executes an application within the GUI 25, 27 that accesses the document database and enables documents to be edited by both first and second parties P₁, P₂, which minimizes processing resources and data storage needed to send drafts back and forth between the first and second parties P₁, P₂ and eliminates errors from drafts crossing paths. In an embodiment, edits made by one of the first party P₁ and the second party P₂ causes the system 110 to generate a useable edit icon 180 on the GUI 25, 27 of the other of the first party P₁ and the second party P₂ which links the other party directly to a page within the document database 124 showing the edits. In an embodiment, the useable edit icon 180 causes the system 110 to link directly to the document database and open a document editing application on the GUI 25, 27 of the other of the first party P₁ and the second party P₂ without the first party P₁ or the second party P₂ having to separately navigate to the document editing application.

In an embodiment, the system 110 provides AI-powered provider matching. For example, the system 110 is configured to run an advanced artificial intelligence (AI) algorithm to match first parties (e.g., clients) P₁ with the most suitable second parties P₂ (e.g., service providers), or vice versa, based on their specific needs, expertise, location, and user preferences.

In an embodiment, the system 110 trains a neural network to retrieve bids for a service from a plurality of second party P₂ external service providers, as discussed in more detail below. The system 110 collects data relating to a plurality of bids for a service to be performed by one or more of the plurality of external service providers. The system 110 also retrieves data from one or more public data sources for each of the plurality of external service providers through one or more application protocol interfaces, for example, from a time entry database 18, a third-party database 19 or a quote generation database 23. Once the system 110 receives a selection of at least one of the plurality of bids for the service as an accepted bid from the first party P₁, the system creates first and second training sets. The first training set includes data regarding the accepted bid and the data from the public data source for the external service provider corresponding to the accepted bid. The second training set includes data regarding others of the plurality of bids for the service that were not selected, and corresponding data from the public source for the external service providers that were not selected. The system 110 then trains the neural network in a first stage using the first training set and in a second stage using the second training set, so that future uses of the neural network highlight or prioritize bids that are more likely to be selected by the first party P₁. In an embodiment, the system 110 thereafter uses the neural network to highlight or prioritize how the order of bids are displayed on the GUI 25 for selection by the first party P₁.

In an embodiment, the first data set includes an overall rating, number of employees, one or more areas of expertise, one or more billing rates, a diversity rating, one or more average billing rate across multiple users U, one or more time periods, an engagement type, or other information associated with the second party P₂ providing the selected bid. In an embodiment, the second data set includes an overall rating, number of employees, one or more areas of expertise, one or more billing rates, a diversity rating, one or more average billing rate across multiple users U, one or more time periods, an engagement type, or other information associated with one or more second party P₂ providing an unselected bid. In an embodiment, the first data set includes tags related to the second party P₂ providing the selected bid that the second party P₂ has entered into system 110 as identifiers or specialties. In an embodiment, the second data set includes tags related to the second party P₂ providing an unselected bid that the second party P₂ has entered into system 110 as identifiers or specialties. In an embodiment, the tags are further included in the first data set and the second data set.

In an embodiment, the system 110 includes an intelligent proposal evaluation engine that automatically evaluates and scores proposal submissions based on predefined criteria, saving time and effort for clients in the selection process. For example, in an embodiment, the first party uses the GUI 25 to designate certain criteria as being critical or non-critical. The system 110 is then configured to weight the data differently to generate a score for each of the submissions. In an embodiment, the system 110 uses the generated scores to prioritize how the order of bids are displayed on the GUI 25 for selection by the first party P₁. In an embodiment, the system 110 further informs the second parties P₂ using the GUI 27 of certain changes that can be made to the proposals to increase the generated score and make selection of the bid by the first party P₁ more likely. The system 110 is configured to inform the second parties using a large language model (LLM) or RAG retrieval process using output from the trained neural network, as discussed in more detail below.

In an embodiment, the system 110 includes dynamic real-time bidding and auction functionality through the use of the real-time bidding and auction engine 116 that allows second parties P₂ (e.g., service providers) to bid on client projects by the first party P₁ to enable competitive pricing and efficient selection of second parties P₂ for the client projects. The real-time bidding and auction application can be executed within a GUI 25, 27 in accordance with the present disclosure so that users U do not have to navigate and open separate applications during use of the system 110, thus minimizing processing resources and saving time for the user U.

In an embodiment, the system 110 includes an interactive contract negotiation platform that facilitates real-time collaboration between first parties P₁ and second parties P₂ during contract negotiation, with features such as live document editing, commenting, and instant messaging. In an embodiment, the system 110 executes an application within the GUI 25, 27 that enables contracts to be edited by both first and second parties P₁, P₂, which minimizes processing resources and data storage needed to send drafts back and forth between the first and second parties P₁, P₂ and eliminates errors from drafts crossing paths. In an embodiment, edits made by one of the first parties P₁ and second parties P₂ causes the system 110 to generate a useable edit icon 182 of the GUI 25, 27 of the other party which links the other party directly to a page showing the edits. In an embodiment, the useable edit icon 182 causes the system 110 to open a document editing application without having to separately navigate to the document editing application.

In an embodiment, the system 110 includes blockchain-powered secure payment and invoicing applications to ensure secure and transparent payment processing and invoicing, enhancing trust and reducing fraud risks in financial transactions. In the illustrated embodiment, the blockchain-powered secure payment and invoicing is enabled through communication with the third-party payment platforms 146 via the dedicated application programming interface 122 through the firewall 126.

In an embodiment, the system 110 includes advanced work-in-progress (WIP) tracking and reporting tools that capture and analyze detailed information about the progress, time spent, and costs associated with ongoing legal matters, enabling accurate reporting and forecasting. In an embodiment, the system 110 executes an application within the GUI 25, 27 that enables WIP tracking and reporting tools, which reduces processing resources and saves the user from having to open and navigate separate applications for these features. In an embodiment, changes to a WIP report above a given threshold cause a useable icon 184 having a link to the revised WIP report. In an embodiment, the system 100 timestamps first users FU and second users SU logging into or otherwise viewing the WIP report, and creates the useable icon 184 on the GUI 25, 27 of users with timestamps meeting a predetermined time threshold. In an embodiment, the system only generates the icon on one of the GUI 25 of the first users FU or the GUI 27 used by the second users SU based on whether the edit was made by a first user FU or a second user SU.

In an embodiment, the system 110 includes intelligent matter management and progress tracking. Intelligent matter management features automate progress tracking, milestone management, and task assignment to ensure efficient collaboration and timely completion of legal matters. In an embodiment, the system 110 executes an application within the GUI 25, 27 that enables the matter management and progress tracking, which reduces processing resources while saving the user from having to open and navigate separate applications for these features.

In an embodiment, the system 110 includes an integrated dispute resolution and customer support center. A comprehensive dispute resolution and customer support center is integrated within the portal of the system 110 to provide first parties P₁ and second parties P₂ with a streamlined process to submit disputes, track progress, and receive prompt assistance. The system 110 further enables the first party P₁ to partially or fully reject an invoice from one or more second parties P₂, and to partially or fully pay the invoice using an application executed within the GUI 25, 27 to increase security of the transaction, and reduce processing while saving the user from having to open and navigate separate applications for these features.

In an embodiment, the system 110 executes an application within the GUI 25, 27, which provides advanced analytics and performance reporting to the first party P₁ with actionable insights, performance reports, and data-driven recommendations for optimizing legal operations and decision-making.

In the illustrated embodiment, the system 110 includes systems applications and products (SAP) software that processes data from all functions in the single platform 111 to facilitate communication between the first parties P₁ and the second parties P₂ in a secure environment. A cloud platform allows the SAP application programming interface (API) 122 to be created, updated and/or evaluated. In the illustrated embodiment, the system 110 includes a billing gateway 119 that provides direct billing of the first parties P₁ and the second parties P₂ through the SAP application programming interface 122. The billing gateway 119 allows for any method of billing desired by the first parties P₁ or the second parties P₂.

In the illustrated embodiment, first parties 12 or second parties P₂ can include large corporations 142 and 144, as shown in FIG. 3, including a plurality of subsidiaries 142a, 142b and 142n of the corporation 142. Each subsidiary 142a, 142b and 142n can interact through the system 110 through the firewall 126, or the corporations 142 and 144 can interact through the system 110 through the firewall 126. The system 110 enables the subsidiaries to interact even if they use different operating systems to access the platform 111.

In an embodiment, the system 110 enables payment through third-party payment platforms 146 for any transaction conducted through the system 110. As seen in FIG. 3, the system 112 integrates third-party payment platforms 146 which cross the firewall 126, bypass the routing gateway 123, and integrate with the platform 111 via the dedicated application programming interface 122. In an embodiment, the system 110 executes an application within the GUI 25, 27 that payment through the third party platforms 146, which reduces processing resources while saving the user from having to open and navigate separate applications for these features.

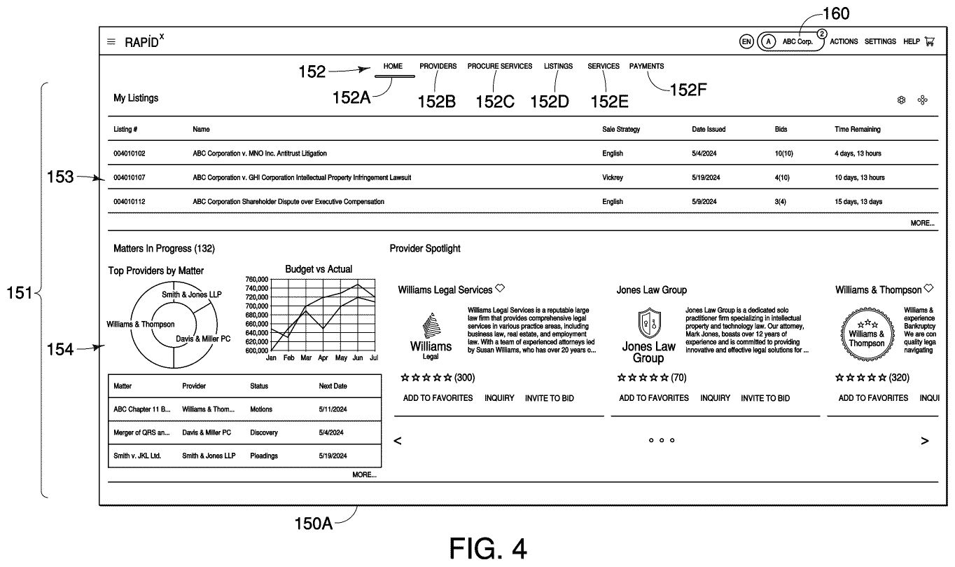

In an embodiment, upon logging into the system 110 through a first user terminal 14 or a second user terminal 15 (FIG. 1), a user U is presented with a query regarding whether the user U is a first party P₁ (e.g., a company seeking a service provider) or a second party P₂ (e.g., a legal service provider). When the user U identifies themselves as a first party P₁, the user U is presented with a GUI 25, for example, as shown in FIGS. 4 to 17. In FIG. 4, for example, the logged in user is identified in a window 160 on the first GUI 150A. As discussed in more detail below, the GUI 25 exemplified in FIGS. 4 to 17 has a common application section 151 where several functional applications are executed and swapped based on the user U selecting one of several options in the application bar 152. This particular manner of retrieving and presenting information using the GUI 25 is enabled by the architecture shown in FIG. 3. By retrieving and presenting information using the common application section 151 of the GUI 25 in this manner, the system 110 further saves the user U from having to navigate to separate applications, open them up, and then navigate within those applications to enable data of interest to be seen and/or functions of interest to be activated. In the illustrated embodiment shown in FIGS. 4 to 17, the application bar 152 includes a plurality of application icons, such as, but not limited to, a home application icon 152A, a providers application icon 152B, a procure services application icon 152C, a listings application icon 152D, a services application icon 152E and a payments application icon 152F. Those of ordinary skill in the art will recognize from this disclosure that other applications can further be retrieved and presented in a similar manner using the common application section 151 of the GUI 25. In an embodiment, some but not all of the icons cause applications to be executed and displayed using the common application section 151. In an embodiment, the system limits or generates icons based on permissions given to and/or authentications provided by the user U.

FIG. 4 illustrates a first GUI 150A executing a first application, data from which is presented to the user U of a first party P₁ using the common application section 151. In the illustrated embodiment, the first application retrieves matter data so as to provide a listing of matters 153 in line-item form. The first application also retrieves third party data regarding progress in pending matters and combines the third-party data with local data to transforms the data into useful graphical illustration 154 demonstrative of progress.

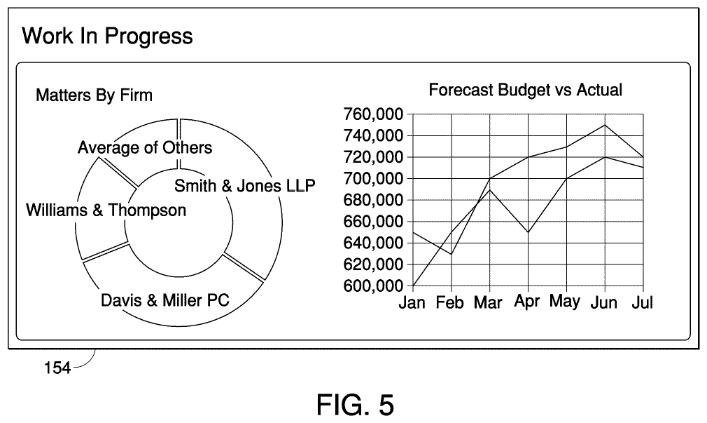

FIG. 5 illustrates an example embodiment of a graphical illustration 154 generated by the first application within the common application section 151 using remote third-party data combined with local data. In the illustrated embodiment, the central memory 22 stores forecast budget data when each new bid is accepted, and the central processor 20 is configured to access data from third party sources, for example, from a time entry database 18, a third-party database 19 or a quote generation database 23. Using the data from the accepted bid stored in the central memory 22 along with the retrieved time entry data regarding hours and milestones, the processor 20 is configured to compute the progress of the project along with the current budget used versus projected from the bid. The processor 30 is configured to transform this combination of data into graphical illustration for display using the GUI 25, for example, as shown in FIG. 5. In an embodiment, the system 110 tracks the progress by accessing data from the time entry database 18, and provides an alert to the first party P₁ and/or the second party P₂ when a predetermined threshold amount of the budget is reached as determined by the amount of time entered using a time entry database 18.

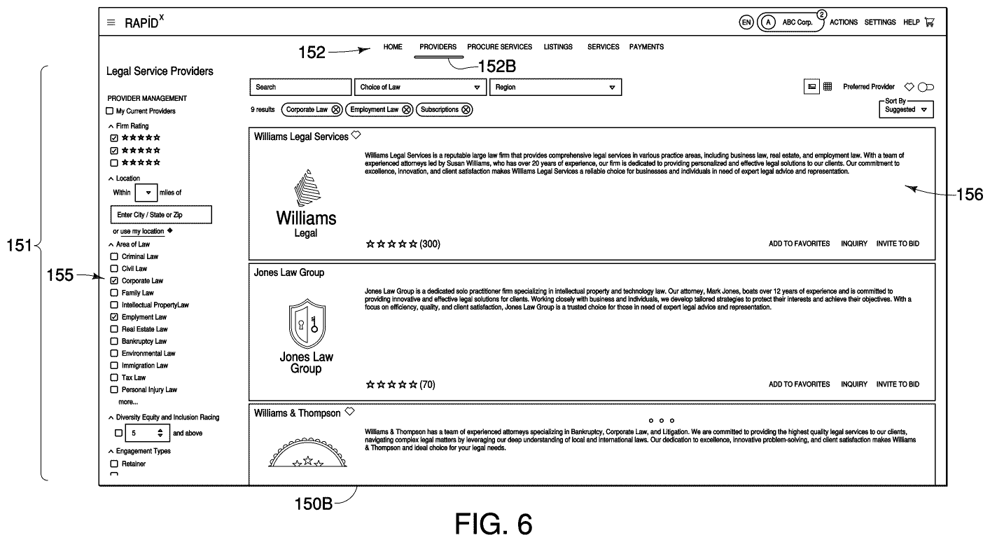

FIG. 6 illustrates an exemplary embodiment of a second GUI 150B executing a second application, data from which is displayed on the first user terminal 14 upon the user U selecting the providers application icon 152B from the application bar 152. Upon selection, the second GUI 150B swaps out the common application section 151 to allow the user U to search for legal service providers using filters 155 to identify criteria for a desired service. In the illustrated embodiment, the filters 155 can include, but are not limited to, a firm rating, a location within a predetermined distance from an input location, an area of law, a diversity, equity and inclusion rating, and an engagement type. In an embodiment, this information is stored in the second party database 116. This information can be provided by the second parties P₂ and/or retrieved by the central processor 20 from second party databases 19 and/or content databases 23. The second GUI 150B is also configured to update the listing of legal services providers 156 that meet the input search filters 155. The second GUI 150B is configured to prioritized data from the second party database 116 based on at least one selection made by the user U using the input search filters 155. The second GUI 150B is also configured to enable the first party P₁ to select at least one of the second parties as a service provider. In an embodiment, the selected input filters are used to determine the data used by the first and second training sets for the neural network as discussed herein.

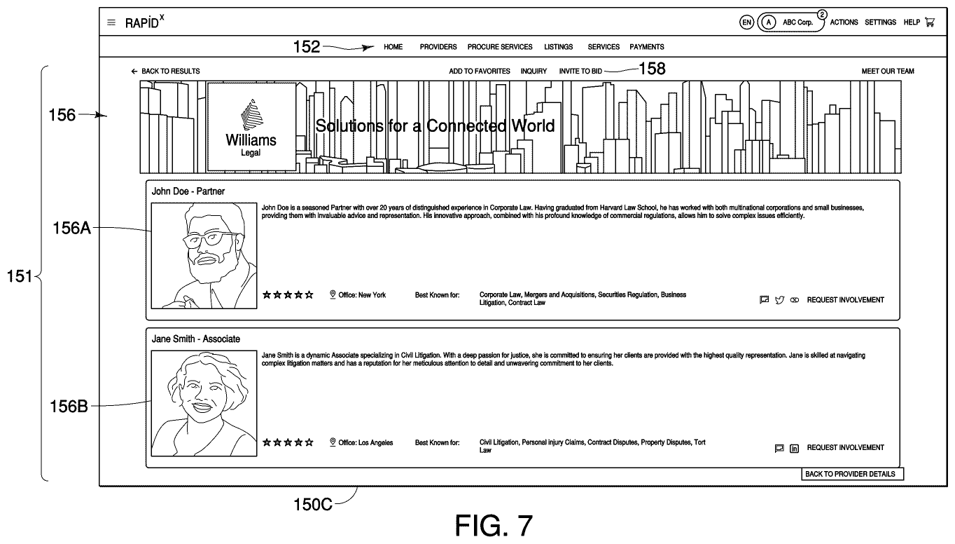

FIG. 7 illustrates an exemplary embodiment of a third GUI 150C executing a third application, data from which is displayed on the first user terminal 14 upon the user U selecting one of the returned service providers 156 on the second GUI 150B. Upon selection, the third GUI 150C swaps the common application section 151 to display a listing for the selected service provider 156, including each individual 156A and 156B associated with a profile for the service provider 156. A professional biography for each noted individual can also be presented. The listing for each service provider 156 can be customized and modified by respective second parties P₂. In an embodiment, an artificial intelligence algorithm is used to generate the profile for the service provider 156. The artificial intelligence algorithm can be trained to gather information about the service provider from various databases 19, and then aggregate the information to generate the third GUI 150C corresponding to the service provider. In an embodiment, the corresponding second party P₂ can then customize the information in the third GUI 150C as aggregated by the artificial intelligence algorithm, as discussed in more detail below. The customizations can be used as part of the first and second training sets for the neural network as discussed herein, thereby constantly improving the system 10, 110 throughout use. The third GUI 150C further includes prompts 158 allowing a user to directly transmit an inquiry to the service provider or to directly invite the service provider to bid on a matter the client has opened for bidding. In an embodiment, when an inquiry or invite is directly transmitted to the service provider, the system 10, 110 links to service provider data on a local or cloud second party database 116 for execution of the methods discussed herein.

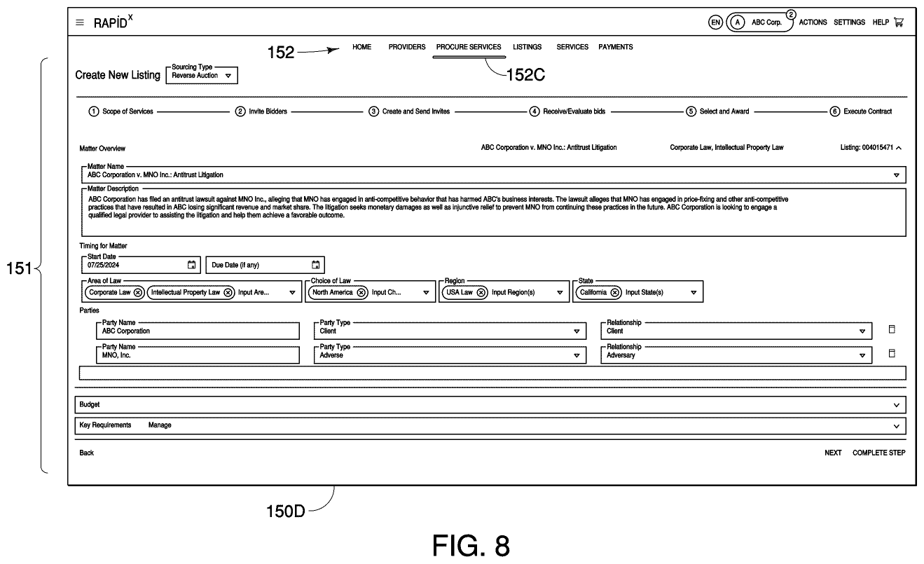

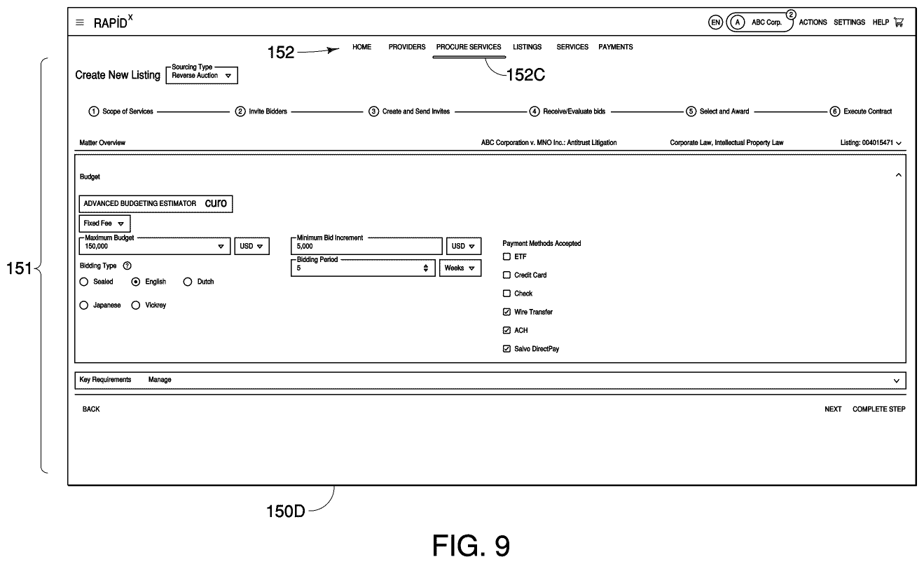

FIGS. 8 to 11 illustrate exemplary embodiments of a fourth GUI 150D executing a fourth application, data from which is displayed on the first user terminal 14 upon the user U selecting the procure services application icon 152C from the application bar 152. Upon selection, the fourth GUI 150D swaps the common application section 151 to display a screen for the user U from the first party P₁ to generate a listing to solicit bids for a matter. In the illustrated embodiment of FIG. 8, the user U is opening a matter directed to antitrust litigation. The fourth GUI 150D enables the user U to indicate start and end dates for the matter, the area of law, the choice of law, the region, the state and the adverse parties. Inputting information allows a service provider to perform a conflict check. Data from the second parties P₂ corresponding to one or more of these categories can be stored in the second party database 116 and used as part of the first or second training sets used to train the neural network. As shown in FIG. 9, the fourth GUI 150D enables the user U to set the type of fee (e.g., fixed fee or hourly fee) and a maximum budget. The fourth GUI 150D also enables the user U to set a minimum increment to prevent a bidder from undercutting a bid by a token amount. The fourth GUI 150D also enables the user U to set a time period for which the bid remains open. The fourth GUI 150D also enables the user U to indicate acceptable forms of payment. Data from the second parties P₂ corresponding to one or more of these options can also be stored in the second party database 116. The information inputted into the fourth GUI 150D can then be used to run the auction engine 117.

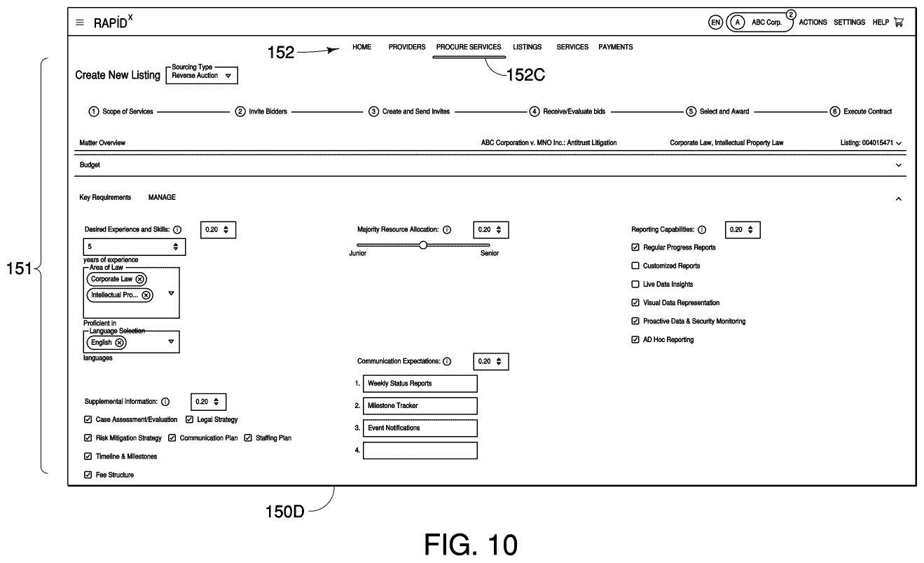

FIG. 10 illustrates how the fourth GUI 150D enables a user to set weights associated with selected requirements which can be used by the fourth application. For example, as shown in FIG. 10, the desired experience and skill of the bidding legal service provider is set at 20%. Other factors can be added or deleted as desired by the user U to generate a customizable request for a bid. The weight associated with each factor can also be set as desired by the user U. The bidding legal service provider can also assign weights to factors presented in their bid, which are then used during execution of the auction engine 117. The system 110 uses the selection of payment methods accepted activate the appropriate connections to one or more, but not all, of the third-party payment platforms 146 through the dedicated API 122.

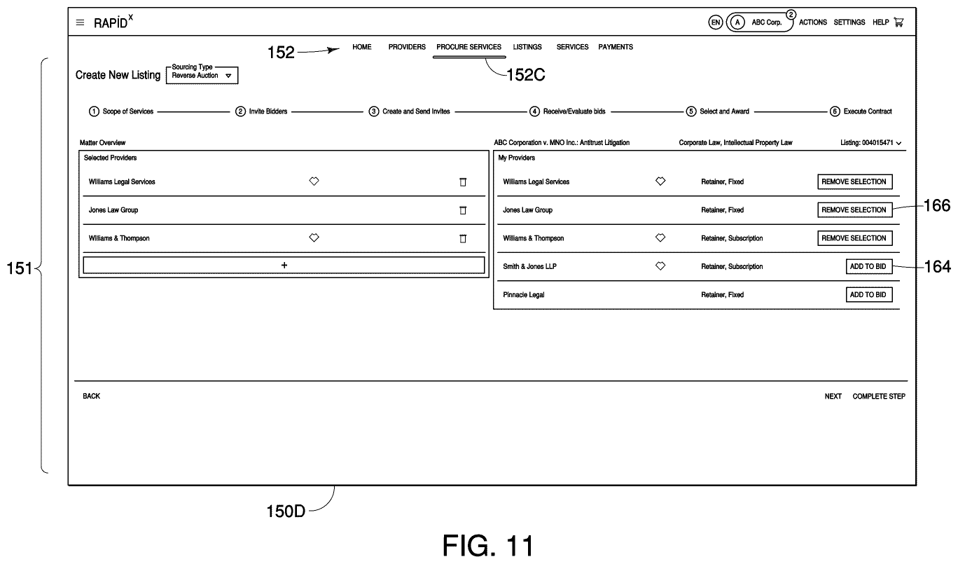

FIG. 11 illustrates how the fourth GUI 150D enables the user U to assign legal service providers to a bid listing for the generated matter. A toggle window 164 allows the user to assign a legal service provider to the bid listing for the generated matter. Another toggle window 166 allows the user to unassign an assigned legal service provider prior to opening the matter to bidding.

In an embodiment, actions taken by a first party P₁ using a GUI 25 on a first user terminal 14 cause generation of one or more useable icons 186 on the GUI 27 of a second user terminal 15 used by a second party P₂. In an embodiment, the user U of a first party P₁ selects a plurality of second parties P₂ to receive bids from. When the first party P₁ assigns a second party P₂ to a bid listing for a generated matter using a GUI 25, a useable icon 186 having a link to a quote generation application already populated with inputs from the first party P₁ is generated on the GUI 27 of that second party P₂, which the second party P₂ can select to make the bid. In an embodiment, the useable icon 186 is associated with a link to a quote generation application of a quote generation database 23. When selected by a second party P₂, the useable icon 186 generated on the GUI 27 is configured to directly opens a quote generation application for the second party P₂. In an embodiment, the system 110 executes the quote generation application within the GUI 27, which reduces processing resources and saves the user U of the second party P₂ from having to open and navigate a separate application. Navigating the quote generation application in this manner also ensures that the first party P₁ receives uniform quotes from a plurality of second parties P₂ which may be on different operating systems and/or typically use other applications to generate quotes.

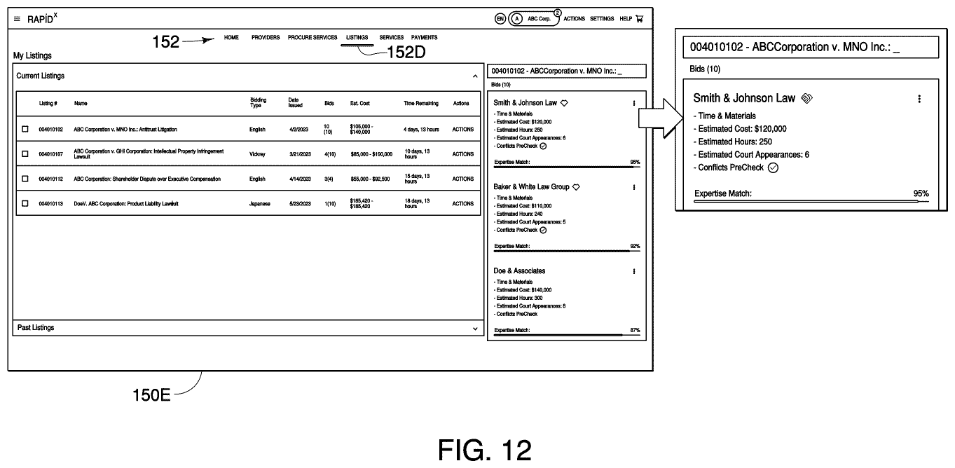

FIG. 12 illustrates an exemplary embodiments of a fifth GUI 150E executing a fifth application, data from which is displayed on the first user terminal 14 upon selecting the listing application icon 152D from the application bar 152. The fifth GUI 150E enables the user U to review the details of any current bid listings and the bids received for those listings. In an embodiment, actions taken by a second party P₂ using a GUI 27 cause a useable icon to be generated and displayed on a GUI 25, which a user can then select to directly access information related to the bid provided by the second party P₂.

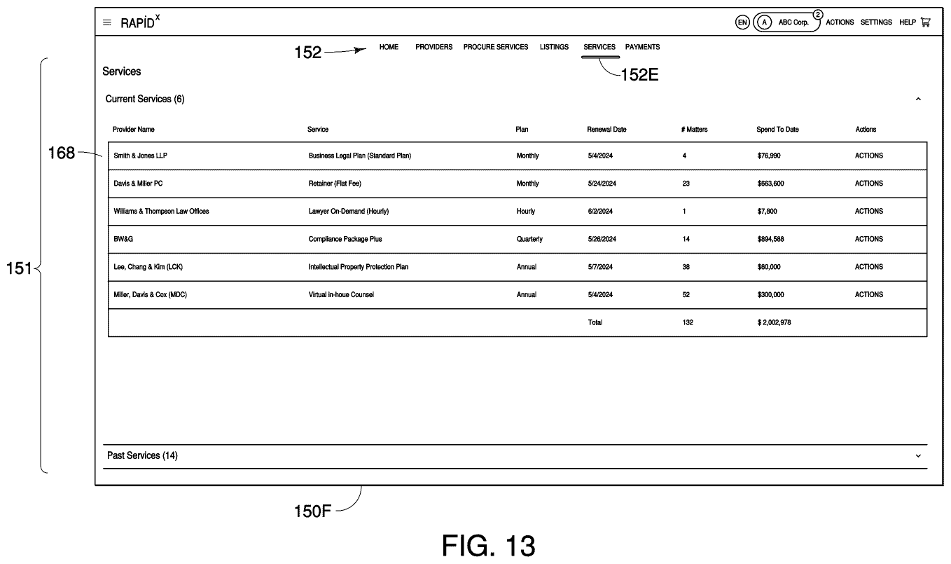

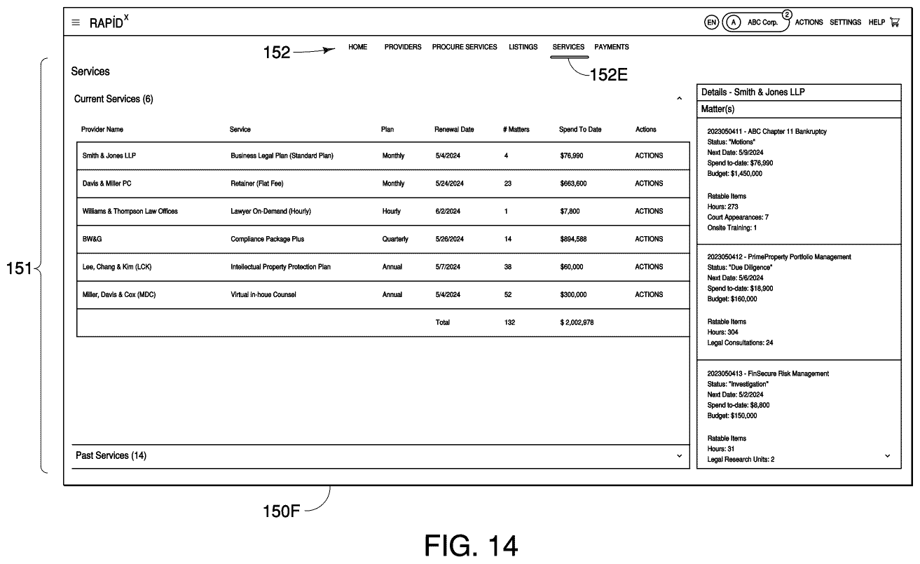

FIGS. 13 and 14 illustrate exemplary embodiments of a sixth GUI 150F executing a sixth application, data from which is displayed on the first user terminal 14 upon selecting the services application icon 152E from the application bar 152. In FIG. 13, the fifth GUI 150E displays a listing of service providers, the type of service being provided, a renewal date for the provided services, the number of matters currently being worked on by the legal service provider, and the amount spent to date on the matters. In an embodiment, this data can be stored in the second party database 116 and/or used in a first or second training set. Selecting one of the service providers 168 in FIG. 13 causes the detailed information for each open matter associated with the selected service provider 168 to be displayed, as shown in FIG. 14. The detailed information for each open matter includes, but is not limited to, a name of the matter, a status, a next due date, a total amount spent to date, a budget and ratable items.

In an embodiment, the services displayed on the sixth GUI 150E can include a subscription model in which the services include a predetermined number of units per a predetermined time period. For example, a legal service provider can be retained to file five patent applications per month for the user. The subscription model allows the user to purchase additional units, e.g., patent applications, during the predetermined time period.

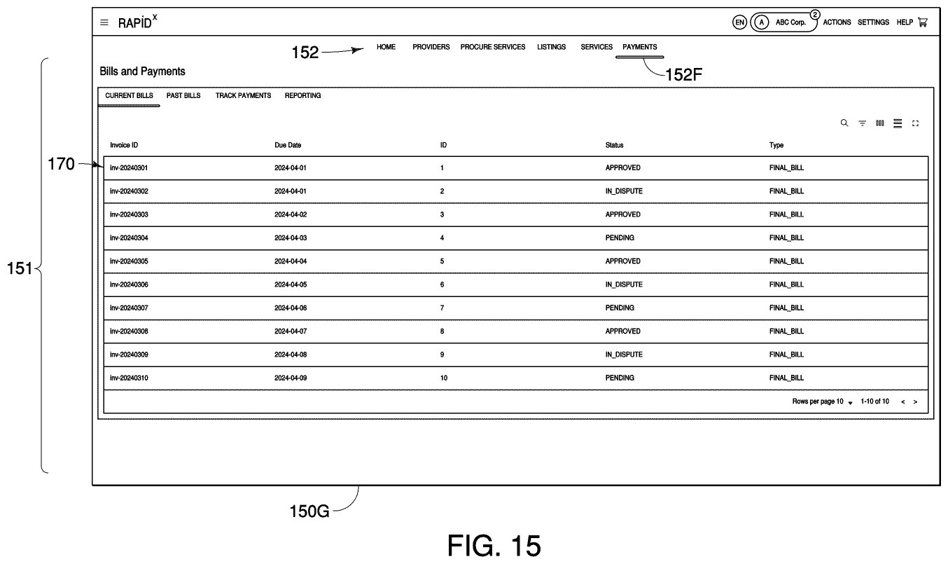

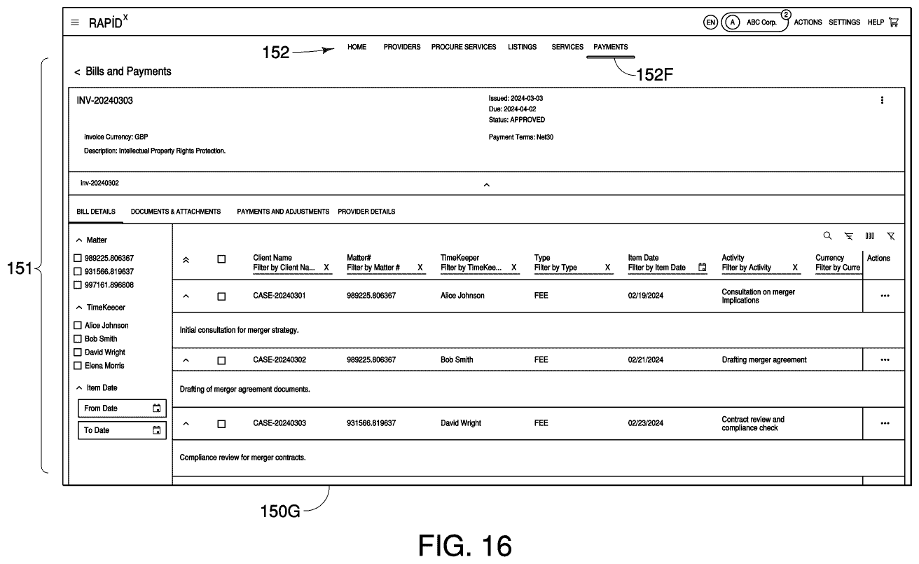

FIGS. 15 and 16 illustrate exemplary embodiments of a seventh GUI 150G executing a seventh application, data from which is displayed on the first user terminal 14 upon selecting the payments application icon 152F from the application bar 152. As shown in FIG. 15, a listing of current bills is displayed to the user. Each bill listing 170 includes an invoice number, a due date, an identification number, a status, and a type of bill. In an embodiment, this data can be stored in the second party database 116. The seventh GUI 150G also presents options to view past bills, to track payments and to generate a report.

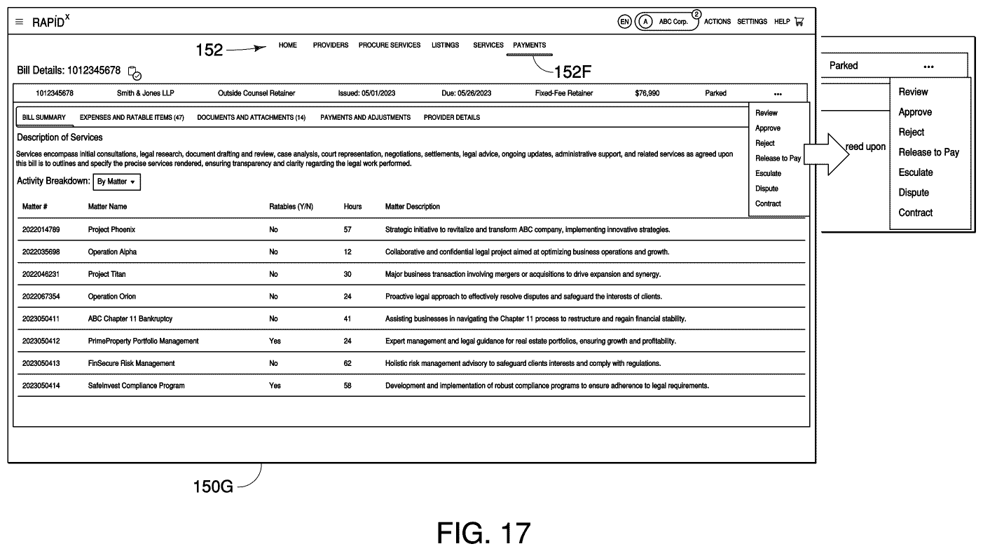

Upon selecting one of the listed current bills 170, the seventh GUI 150G displays detailed information for the selected bill, as shown in FIG. 16. The bill details allow the user to filter and/or sort the detailed information, such as by matter number, timekeeper or for a desired time period. As shown in FIG. 17, the seventh GUI 150G enables a user U of the first party P₁ to select amongst a plurality of options 172 to pay the bill. In the illustrated embodiment, the user U can review, approve, reject, release to pay, escalate, dispute or contact.

The invoices received by the client from the service provider are validated by the service provider prior to being received by the client, as indicated in the status column in FIG. 15. The client can request an adjustment in real time through the seventh GUI 150G directly to the service provider that generated the invoice. The requested adjustment can be directed to the entire invoice or can be specifically directed to a line item of the invoice. The service provider will see the request for the invoice adjustment when logging into the system 110, and can respond accordingly. The payment can be made to pay a minimum indicated amount, the full balance for the service provider, the full amount of the invoice, or any other agreed to payment amount set forth in advance with the service provider.

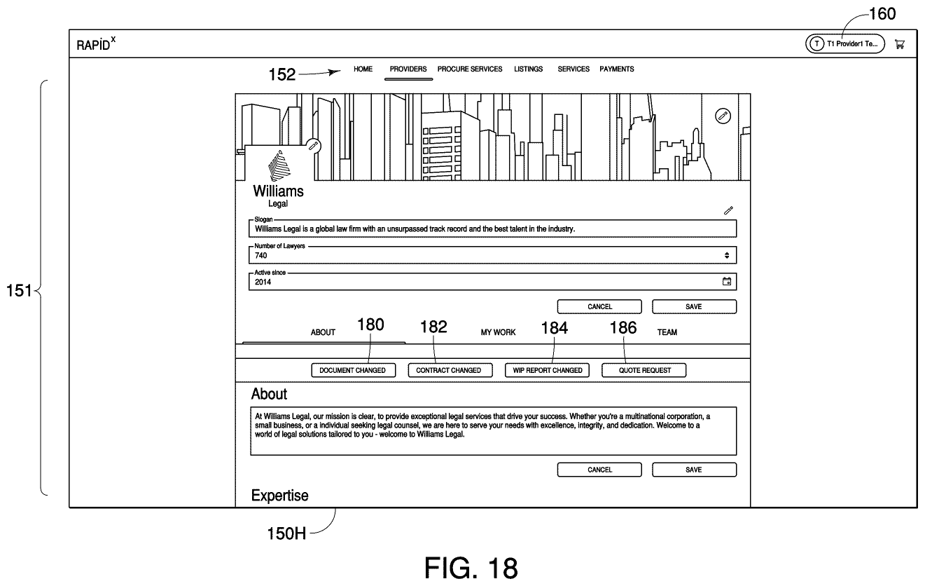

When the user U logging into the system 110 through a user terminal 14 (e.g., FIG. 1) identifies themselves as a second party P₂ (e.g., a service provider), the user U is presented with an eighth GUI 150H, as shown in FIG. 18, on the first user terminal 14. The window 160 identifies the logged-in service provider. The eighth GUI 150H is a home page for a service provider, and allows for customization of information regarding the service provider. The service provider can designate information that is available to the public or that is private and available only to designated users. The information can then be stored in the second party database 116. The application bar 152 is substantially similar to the navigation menu presented to a client, and allows the service provider to conduct transactions similar to those described above with respect to a client. Information entered by the service provider can be used in the first or second training sets for training the neural network. The information used by in the first and second training set can be private information provided by the second party P₂ that is not viewable by the first party P₁ but is used in a first or second training set to train the neural network to be more accurate. In this way, the neural network improves accuracy without disclosing private details about the second party P₂ to the first party P₁.

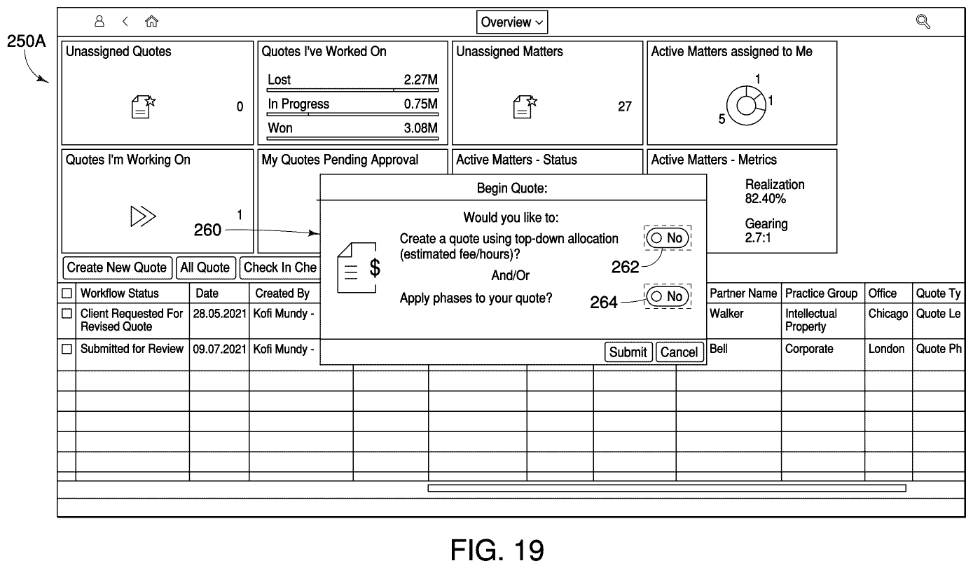

In an embodiment, the system 10, 110 enhances or transforms data from an internal or external quote generation database 23. In an embodiment, the quote generation database 23 is a quote generation system used by the second party P₂. FIGS. 19 to 23 illustrate an example embodiment of GUIs 25, 27 related to a quote generation database 23 that can be generated at one or more user terminal 14, 15. It should be understood by those of ordinary skill in the art from this disclosure that the disclosed GUIs 25, 27 improve the user experience, conserve user time, and prevent errors in generated quotes, while the system 10, 110 as a whole achieves improved processing efficiency and memory storage via the data enhancement and transformation methods used to generate and transform the data from the GUIs 25, 27.

FIG. 19 illustrates an example embodiment of a first GUI 250A displayed on a user terminal 14, 15 of a user U in accordance with the present disclosure. As illustrated, first GUI 250A displays a quote creation panel 260 enabling a user U to create a new quote. In the illustrated embodiment, the quote creation panel 260 provides the user U with at least two options 262, 264 for creation of the new quote. The first option 262 is to create a new quote using top-down allocation. The second option 264 is to apply phases to the new quote. The quote generation database 23 enables the user U to select one or both of the two options 262, 264. Enabling these two options 262A, 262B for the user U creates flexibility to tailor a quote for the needs of the first party P₁, while also conserving processing power and memory space by avoiding the processing and storage of unnecessary data.

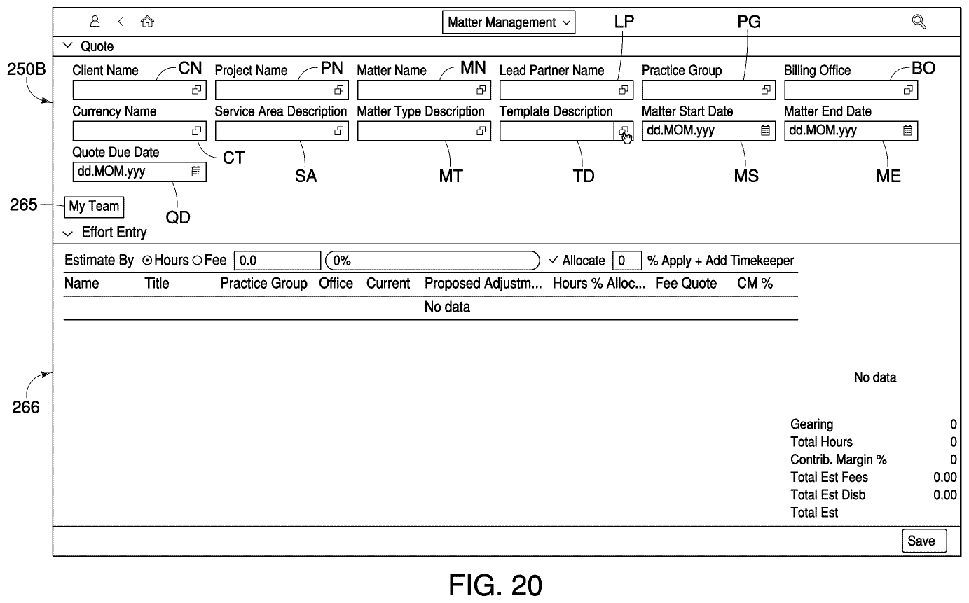

FIG. 20 illustrates an example embodiment of a second GUI 250B displayed on a user terminal 14, 15 of a user U in accordance with the present disclosure. In the illustrated embodiment, the second GUI 250B is displayed when the user U selects the submit icon on the quote creation panel 260 of the first GUI 250A. Here, the user U has selected to perform a top-down allocation using the first option 262 of the first GUI 250A, but has not selected to use phases using the second option 264 of the first GUI 250A. As illustrated, the second GUI 250B enables the user U to input a variety of input data regarding the new quote. In the illustrated embodiment, this input data includes the client name CN, project name PN, matter name MN, lead partner name LP, practice group PG, billing office BO, currency type CT, service area description SA, matter type description MT, template description TD, matter start date MS, matter end date ME, and quote due date QD. In an embodiment, one or more of these entries can be used in the first or second training sets used to train the neural network as discussed herein. In the illustrated embodiment, the second GUI 250B also includes a team button 265 and a quote creation table 266, which are discussed in more detail below.

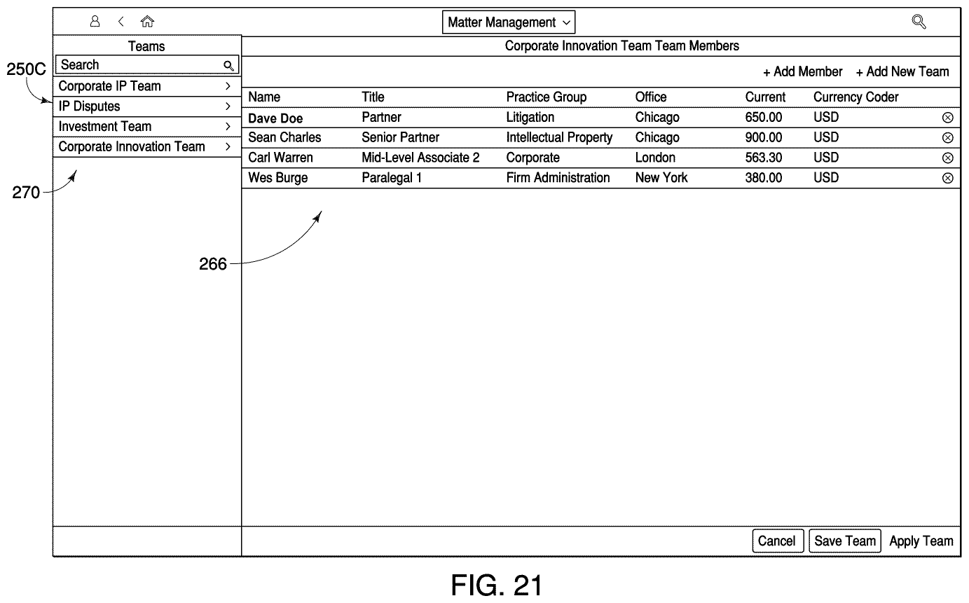

FIG. 21 illustrates an example embodiment of a third GUI 250C displayed on a user terminal 14, 15 of a user U in accordance with the present disclosure. The third GUI 250C is triggered when a user U selects the team button 265 on the second GUI 250B. The third GUI 250C includes a team table 270 and a member table 272. The team table 270 includes a plurality of teams, with each team including a plurality of members shown in the member table 272. In the illustrated embodiment, the members correspond to users U of the service provider. In the illustrated embodiment, the plurality of members for each team make up a team that has worked together in the past, such that the user U creating the quote can be confident that the team is able to work together efficiently and effectively and/or the database 26 already stores data regarding how work is typically divided amongst the team.

The teams shown in the third GUI 250C can be saved on the central memory 22. In an embodiment, the quote generation database 23 is configured to generate a team based on data saved in the quote generation database 23 for a previous or existing client or matter. For example, the quote generation database 23 can retrieve one or more of the billing timekeepers (e.g., workers) for a previous or existing client or matter, create a team including the timekeepers from the previous or existing client or matter, and generate the member table 272 with the members of that team. In this way the user U creating the quote can create a team that the user U knows has worked together for the same client and/or on the same matter in the past. The quote generation database 23 can also store data regarding how work is typically divided amongst the team, which improves the accuracy of the quote and prevents redundant data storage/generation. In an embodiment, the quote generation database 23 determines how work was divided for a previous or existing client, for example, by using the billing hours recorded by each timekeeper in the quote generation database 23 and/or another time entry database 18 to determine the percentage of total work performed by each timekeeper for the client or matter from which the team has been generated. In an embodiment, the quote generation database 23 sends a notification to the user terminal 14, 15 of each user U who is being added as a member of the new team. In an embodiment, each user U can accept or reject being added as a member of a new team via his or her respective user terminal 14, 15 thus ensuring that teams are created with members who are willing and able to handle an additional workload.

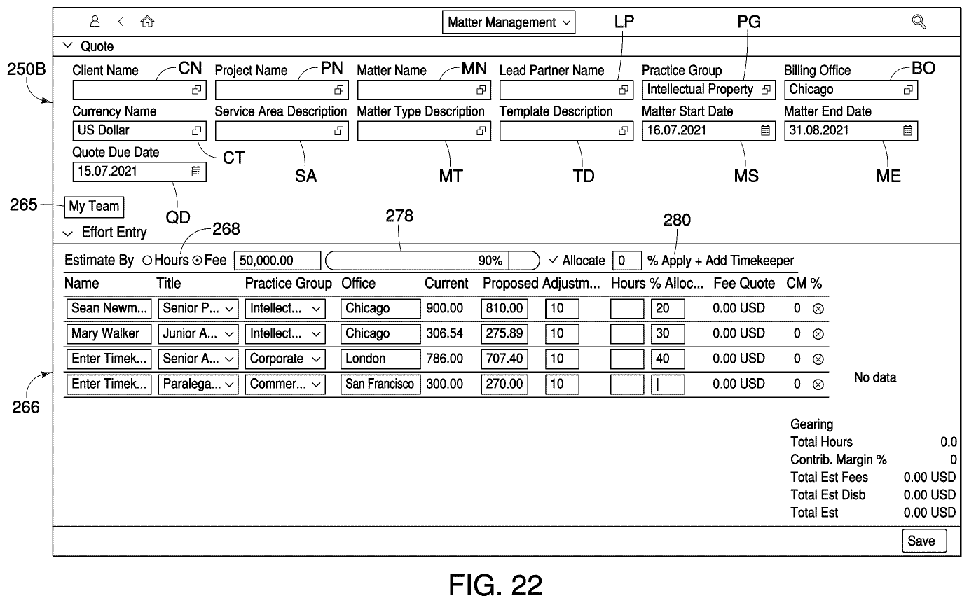

FIG. 22 illustrates the second GUI 250B after the quote generation database 23 has regenerated the quote creation table 266 with the members of a team that has been selected using the third GUI 250C. By automatically regenerating the quote creation table 266 with members of a preexisting team, the quote generation database 23 conserves processing power and memory space using prestored team data instead of generating and processing new team data. The quote generation database 23 further improves the user experience by reducing quote creation time, ensuring that team members who function well together continue to work together, and ensuring that the quote is not missing valuable members of a previous team which could affect the overall budget. In an embodiment, the quote generation database 23 also enables a user U to add additional members to and/or subtract existing members from the quote creation table 266.

In the illustrated embodiment, the second GUI 250B provides the user U with an input selection 268 which enables the user U to choose to create a quote based on hours worked or based on a fixed fee. The second GUI 250B functions differently for each option and is particularly advantageous in ensuring that each member is able to budget the time needed to perform the work in the quote. In FIG. 22, the user U has chosen to create a quote based on a fixed fee. Here, the fixed fee is set at $50,000. For each member (e.g., another user U operating with another user terminal 14, 15), the quote creation table 266 displays basic information, for example, the worker's name, title, practice group, office, and billing rate. The quote generation database 23 also enables an adjustment to be applied to each worker's billing rate. Here, the user U has applied a 10% adjustment to each worker's billing rate, such that the system 10 has automatically reduced each current billing rate by 10% to the proposed billing rate. Here, the hours, fee quote and contribution margin percentage (CM %) are still empty because the user U has not yet finished entering input data and applying the percentage allocation. In the illustrated embodiment, the second GUI 250B also includes an allocation bar 278, which indicates how much of the project is currently allocated (90% in FIG. 22). In an embodiment, the quote generation database 23 prevents the new quote from being completed until the percentage allocation reaches 100%. In an embodiment, the quote generation database 23 automatically adjusts the percentage allocation for one or more members to cause the total percentage allocation to be 100% (e.g., increases each member's percentage allocation by 10% in the illustrated embodiment to adjust from 90% to 100%). In this way, the quote generation database 23 improves the quote accuracy by generating the maximum number of allowable hours for each member to ensure 100% allocation. Further, improved storage space and processor efficiency are additional benefits for the quote accuracy.

In the illustrated embodiment, the quote generation database 23 automatically enables or disables entry of certain information based on the input selection 268 chosen by the user. For example, in an embodiment, when the user selects to create a quote based on hours worked, the quote generation database 23 enables the second GUI 250B to allow the user to enter desired hours for each member in the hours column of the quote creation table 266; however, when the user selects to create a quote based on fixed fee, the quote generation database 23 disables entry of the hours worked and instead automatically generates the hours worked based on the percentage allocation. In another embodiment, the quote generation database 23 allows the user U to enter either the hours and/or the percentage allocation for one or more of the members, and the automatically generates the remaining hours and/or percentage allocation for one or more of the other members in view of the remaining fees available. In these ways, the quote generation database 23 improves processing efficiency and data storage by enhancing minimal information to create a full quote and by preventing the storage of unnecessary data.

In an embodiment, the quote generation database 23 automatically populates the percentage allocations based on previous projects that the team has worked together and other bid data or response data. That is, the quote generation database 23 processes historical data and determines what percentage of the work each member is likely to perform. In this way, the quote generation database 23 creates an accurate quote based on historical worked amounts. In an embodiment, the quote generation database 23 retrieves the historical data. In an embodiment, the time entry database 18 includes time entries for a plurality of matters. The quote generation database 23 can be configured to retrieve time entry data for a matter including multiple members from the time entry database 18 and determine the percentage of work that each of the members performed for that matter. The quote generation database 23 is then configured to use this data to automatically populate the percentage allocations based on previous projects, for example, assuming that the members will work the same percentage amounts for the quote that have been worked for previous matters. Thus, in an embodiment, the user U is simply required to enter a total fee amount and select a team, and the quote generation database 23 transforms the data stored from previous time entries and/or quotes to generate the new quote. In this way, the quote generation database 23 improves processing efficiency and reduces data storage redundancy by enhancing and reusing previously available data for a new application, while also improving the accuracy and acceptability of the new quote based on historical trends. In an embodiment, the user U creating the quote can then accept or adjust the percentage allocations determined by the system 10.

As illustrated, in an embodiment, the quote generation database 23 enables the user U to adjust the allocation percentage. In an embodiment, the quote generation database 23 is also configured to automatically adjust the allocation percentage based on work in progress or other quotes for one or more member. For example, the quote generation database 23 can use input data including at least one of the matter start date MS, matter end date ME and/or estimated duration ED to determine the expected commitment for each member during a particular time period. The quote generation database 23 is configured to determine whether each member is also committed to other work during this time period based on previous quotes, for example, by determining whether the new time period indicated by the input data overlaps with other time periods for which one or more team member has already been committed based on other quotes. The quote generation database 23 can therefore determine whether the percentage allocation and/or total hours for the current quote would push the member over a threshold for a particular time period. In an embodiment, the quote generation database 23 automatically adjusts the allocation percentage to the maximum allowable allocation percentage for that member based on the threshold. In this way, the quote generation database 23 improves processing efficiency and reduces data storage redundancy by enhancing and reusing previously available data for a new application, while also improving the accuracy of the new quote using information regarding how much time one or more member can realistically perform over a given time period.

In an embodiment, the quote generation database 23 sends a notification to the user terminal 14, 15 of each user U who is being added to a new quote after determining that the percentage allocation and/or total hours for the new quote would push the user U over the threshold for a particular time period. In an embodiment, each user U can use his or her user terminal 14, 15 to accept or reject the new quote via his or her respective user terminal 14, 15, thus ensuring that teams are created with members who are willing and able to handle an additional workload. In an embodiment, the system 10 removes the user U as a member of the new team upon rejection of the addition by the user U. In an embodiment, the quote generation database 23 automatically creates a placeholder or adds another member with similar credentials in place of the user U who has rejected the membership.

In an embodiment, the quote generation database 23 stores rules which are implemented to automatically adjust the percentage allocations. For example, the quote generation database 23 can store rules about the minimum or maximum percentage of time that should be spent by certain levels of seniority (e.g., partner must perform at least 10%, junior associate must perform at least 50%, etc.). The system is therefore configured to ensure that particular thresholds are met and/or automatically adjust values when the thresholds have not been met.

In an embodiment, the quote generation database 23 retrieves utilization data for various users U to build a team for a new quote. The quote generation database 23 can retrieve the utilization data from a time entry database. In an embodiment, the quote generation database 23 generates a team based on users U with the lowest overall utilization. This way, the quote generation database 23 ensures that each team member is not being overworked and can effectively perform the work in the quote during the requested time period, and also that the second party P₂ is efficiently and effectively using all employees.

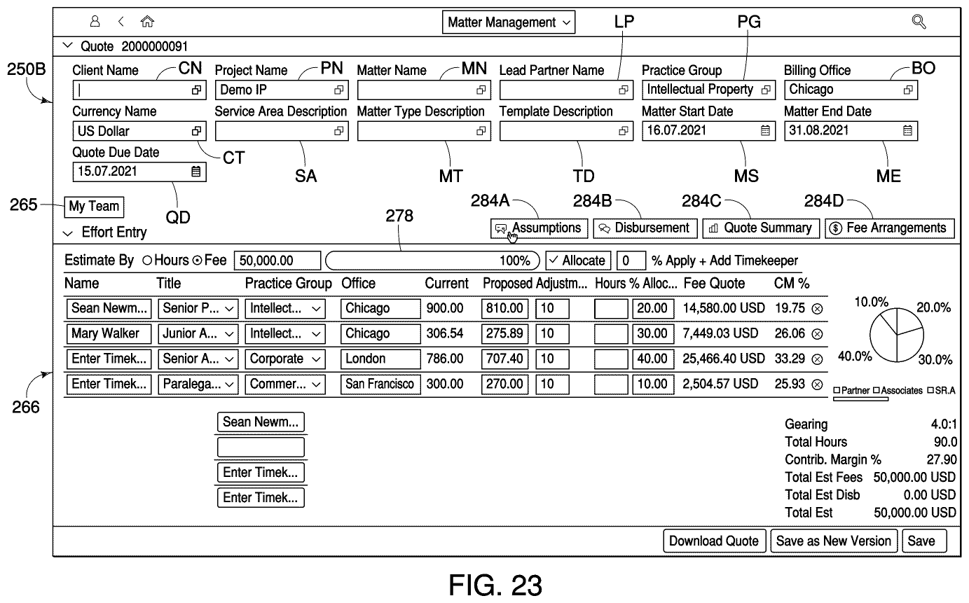

FIG. 23 illustrates the second GUI 250B after the total percentage allocation has reached 100% (e.g., as shown by the allocation bar 278). Here, the quote generation database 23 has regenerated the hours, fee quote and contribution margin percentage (CM %) for each worker. In the illustrated embodiment based on the flat fee (e.g., here, $50,000), the quote generation database 23 generates the hours for each member based on the member's corresponding percentage allocation while also ensuring that the sum of the fee quotes for each member does not exceed the entered flat fee. The quote generation database 23 further determines the fee quote for each member based on the generated hours and proposed billing rate. The quote generation database 23 determines the contribution margin percentage, for example, based by calculating CM as (Fec Quote−Cost)/(Fec Quote). In an embodiment, the quote generation database 23 flags the quote if a particular threshold is not met by the contribution margin percentage.

In an embodiment, FIG. 23 illustrates the second GUI 250B after the user U has pressed the percentage apply button 280. The percentage apply button has triggered the second GUI 250B to generate a plurality of additional icons 284 that can be selected by the user U. The plurality of additional icons 284 includes an assumptions icon 284A, a disbursement icon 284B, a quote-summary icon 284C, and a fee-arrangements icon 284D. The assumptions icon 284A enables the user U to add text tags regarding assumptions to one or more quotes generated as discussed herein. The disbursement icon 284B enables the user U to add additional disbursements to one or more quotes generated as discussed herein. The quote-summary icon 284C generates a summary of the quote. The fee-arrangements icon 284D generates additional data regarding possible fee arrangements with the first party P₁.

In an embodiment, the quote generation database 23 at this point is configured to determine whether each member can handle the workload being quoted. For example, the quote generation database 23 is configured to determine whether the total hours for the new quote would push any member over a predetermined threshold for a particular time period when combined with that member's existing hours that have been committed to an overlapping time period in other quotes. In an embodiment, the quote generation database 23 flags the member (another user U) and sends a notification to user terminal 14, 15 of each user U who has surpassed the threshold. In an embodiment, each user U can use his or her user terminal 14, 15 to accept or reject the new quote via his or her respective user terminal 14, 15. In an embodiment, the quote generation database 23 automatically removes the user U as a member of the new team upon rejection by the user U. In an embodiment, the quote generation database 23 automatically creates a placeholder or adds another member with similar credentials in place of the user U who has rejected the team membership.

In an embodiment, upon determining that a workload threshold has been surpassed, the second GUI 250B informs the user U creating the new quote of the workload conflict. In an embodiment, the second GUI 250B further informs the user U how adjustments can be made so that there is no workload conflict. In an embodiment, the second GUI 250B proposes a new member to replace a conflicted member, with the new member having for example the same title and/or practice group as the conflicted member. In an embodiment, the second GUI 250B proposes a new matter start date MS, matter end date ME and/or estimated duration ED which would allow the conflicted member to complete the desired workload without surpassing the threshold. For example, the conflicted member may already be committed to a previous workload for the initial dates entered by the user U, but may be available if the dates are shifted and/or the duration is extended. In this way, the second GUI 250B ensures that all quotes can be effectively completed by the team members within the particular time period being promised by the quote.

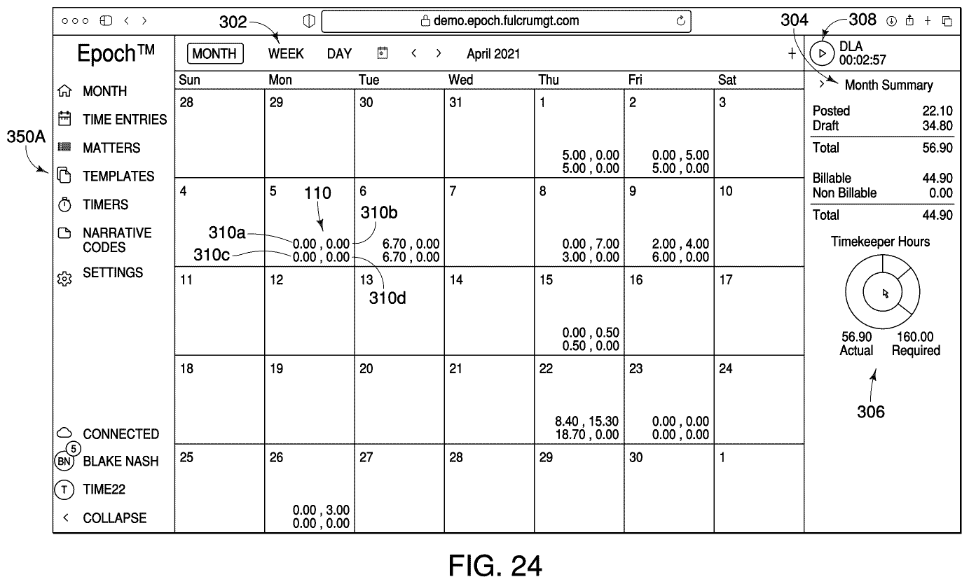

In an embodiment, the system 10, 110 transforms data from an internal or external time entry database 18 that records time data from the second party P₂. FIGS. 24-27 illustrate an example embodiment of GUIs 25, 27 related to a time entry database 18 that can be generated at one or more user terminal 14, 15. It should be understood by those of ordinary skill in the art from this disclosure that the disclosed GUIs 25, 27 improve the user experience, conserve user time, and prevent errors in the documents and GUIs 25, 27 generated by the system 10, 110, while the system 10, 110 as a whole achieves improved processing efficiency and memory storage via the data transformation methods used to generate and transform the data from these GUIs 25, 27.

FIG. 24 illustrates an example embodiment of a first GUI 350A displayed on a user terminal 14, 15 for a user U in accordance with the present disclosure. The first GUI 350A is a home screen configured to display a summary of the time entry data for the respective user U over a predetermined period (here, e.g., a month for a user U). In the illustrated embodiment, the first GUI 350A is in a calendar format to allow a user U to select (e.g., click on) any day to enter time entry data for that day. Here, the calendar format can be set as month, week, or day using a calendar format selection panel 302. The first GUI 350A further includes a month summary panel 304 which shows the time entry statistics for the user U in numerical format and a timekeeper hourly summary panel 306 which shows the time entry statistics for the user U in graphical format. The first GUI 350A further includes a running timer 308. The running timer 308 can be activated or deactivated by the user U by selecting (e.g., clicking on) the illustrated button. When activated, the running timer 308 records the total amount of time until deactivated.

In the illustrated embodiment, the monthly summary panel 304 includes posted time, draft time, billable time, and nonbillable time. The posted time is the total time from one or more time entries that have been finalized for the user U. The draft time is the total time from one or more time entries that have not yet been finalized for the user U. The billable time is total time from one or more time entries that is related to a billable matter that will be included in a billing report from a second party P₂ to a first party P₁. The nonbillable time is the total time from one or more time entries that is related to a billable matter that will not be billed to the first party P₁. A user U can view more detailed summaries of each of these types of time entries by selecting (e.g., clicking on) a respective type using the first GUI 350A. Each of these times is also broken down by individual days within each day of the calendar. Here, each day includes at least one displayed time value 310 for that day. For example, numerous days show a daily posted time value 310a, a daily draft time value 310b, a daily billable time value 310c, and a daily nonbillable time value 310d. In an embodiment, the user U selecting any of these values causes generation of a GUI which includes more details about the time entry data associated with the time value 310.

In an embodiment, the time recorded by the running timer 308 is exported into a time entry 312. More specifically, the time entry database 18 is configured to automatically generate an editable time entry 314 including the time recorded by the running timer 308. For example, stopping the running timer 308 can trigger generation of an editable time entry 314 which includes the total time from the running timer 308. The time entry database 18 is further configured to round the time from the time entry to a specified decimal. In an embodiment, the user U is enabled by the time entry database 18 to set the specified decimal (e.g., 0.1 hrs, 0.25 hrs, 0.5 hrs, etc.) for rounding.

The running timer 308 can be a specific running timer 308 associated with a specific client or matter or can be a general running timer 308 without being associated with a specific client or matter. In an embodiment, a time entry 312, 314 can be generated from either type of running timer 308. If the running timer 308 is not associated with a specific client or matter, the time entry database 18 is configured to create a useable time icon that is configured to be selected by a user U to input additional details regarding client and/or matter. The user U can then convert the useable time icon into the time entry 312, 314 by inputting the specific client number or matter number. If the running timer 308 is associated with a specific client or matter, the time entry database 18 is configured to create a time segment icon which can be converted into a time entry 312, 314 either on its own or in combination with other similar time segment icons as described herein.

In an embodiment, the running timer 308 can be started and stopped on a smart watch controlled by the user U. This allows the user U to enable the running timer 308 when away from a personal computer or another electronic device which displays the GUI 25, 27. In an embodiment, the smart watch exports the total time from the running timer 308, and the time entry database 18 creates a useable time icon, time segment icon and/or time entry 312, 314 on a first GUI 350A as discussed herein. Thus, in an embodiment, a user terminal 14, 15 includes a smart watch with a running timer 308, and a user U can start or stop the running timer 308 as the user goes about his or her day. Each time the user U stops the running timer, the user can export the time data to the central server 12 of the system 10, 110. Then, when the user U accesses his or her data from another user terminal 14, 15 the user U can view and/or edit an editable time entry 314 corresponding to the time recorded with the user U's smart watch. The editable time entry 314 can include, for example, the data and total time that the timer 308 ran for. In an embodiment, the editable time entry 314 can also include or indicate a location based on GPS data from the user U's smart watch to remind the user of where the time was taken, thus reminding the user what the time corresponds to for further editing. In an embodiment, the system 10, 110 uses the time recorded by the watch for example to create the real-time graphical illustration 154 shown in FIGS. 4 and 5 for the first party P₁ to access.

In an embodiment, each time an editable time entry 314 is generated, time entry data corresponding to the time entry is stored. More specifically, the time entry data is stored in the central memory 22 or another memory of the time entry database 18. The time entry data can include, for example, second party P₂ data corresponding to a first party P₁ (e.g., a client number), second party P₂ data corresponding to one or more of a plurality of matters for a first party P₁ (e.g., a matter number), data corresponding to the user U corresponding to the time entry (e.g., a timekeeper number), data related to the date and total time of the time entry, data related to a narrative corresponding to the time entry, and/or the like. In an embodiment, the system 10, 110 then uses this information for example to create the real-time graphical illustration 154 shown in FIGS. 4 and 5 for the first party P₁ to access. The present disclosure improves the storage capacity of the central memory 22 by minimizing time entry data related to individual time entries and linking time entry data where possible, as discussed in more detail below.

In an embodiment, the time entry database 18 causes certain data to be saved on the terminal memory 32 to conserve memory capacity on the central memory 22. In an embodiment, the time entry database 18 stores time entry data on the terminal memory 32 until the time entry data becomes an editable time entry 314. In another embodiment, the time entry database 18 stores time entry data on the terminal memory 32 until the time entry data becomes a posted time entry 112. In an embodiment, when a user U wishes to access certain time entry data from a different user terminal 14, the central processor 20 accesses the terminal memory 32 where the respective time entry data is stored and transfers it to the different user terminal 14, 15. In this way, the time entry database 18 conserves memory space at the central memory 22 by utilizing the terminal memories 32 for certain time entry data. Partitioning the data as part of the method will also increase processor efficiency, neural network training, and storage redundancy.

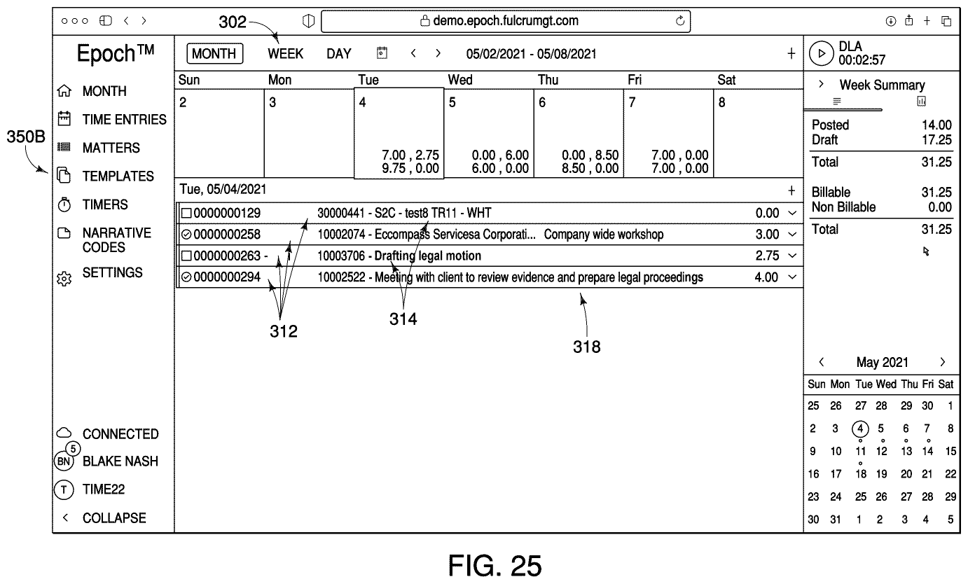

FIG. 25 illustrates an example embodiment of a second GUI 350B displayed on a user terminal 14, 15 for a user U in accordance with the present disclosure. In the illustrated embodiment, the time entry database 18 automatically causes generation of the second GUI 350B when a user U selects a day in the monthly view of the first GUI 350A. That is, clicking on a day in the first GUI 350A has automatically triggered the calendar format selection panel 302 to switch to from the month view to the week view. In the illustrated embodiment, the second GUI 350B includes a daily interface 318 which displays information about the time entries 312, 314 which correspond to the daily posted time 310a, daily draft time 310b, daily billable time 310c, and/or daily nonbillable time 310d in the first GUI 350A. In the illustrated embodiment of FIG. 25, the second GUI 350B is showing four time entries 312, two of which are editable time entries 314, and the other two of which have already posted.

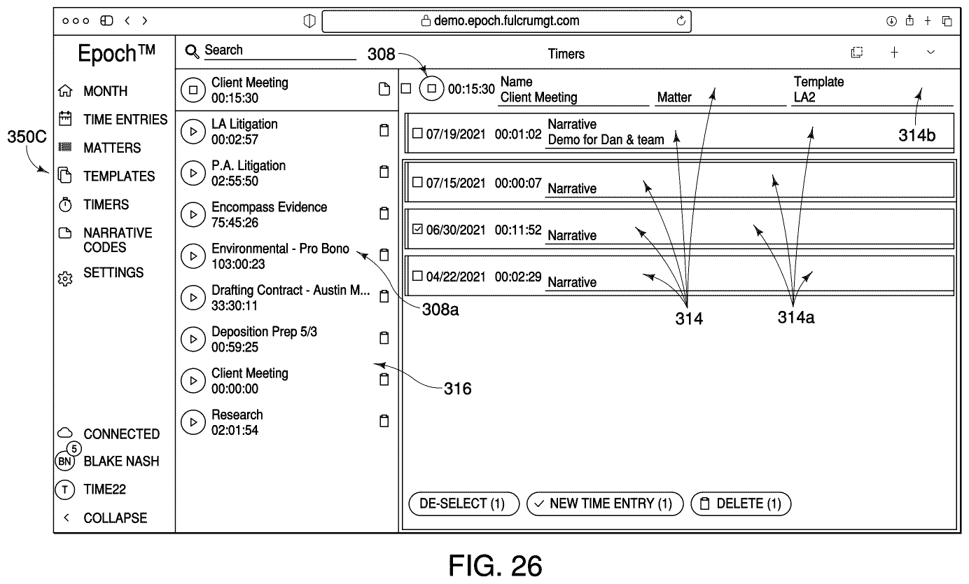

FIG. 26 illustrates an example embodiment of a third GUI 350C displayed on a user terminal 14, 15 for a user U in accordance with the present disclosure. When the time entry database 18 exports the time recorded by the running timer 308 into an editable time entry 314, the editable time entries 314 are displayed in the third GUI 350C. In an embodiment, the editable time entry includes an amount of time transmitted to the central server 12 from a user U's smart watch. In the illustrated embodiment, the third GUI 350C displays a first view 314a for a plurality of editable time entries 314. The first view 314a corresponds to editable time entries in which the running timer 308 has already started, stopped and triggered the generation of the first view 314a. The third GUI 350C also displays a second view 314b for an editable time entry 314. The second view 314b includes the running time 308. When a user U clicks on the running timer 308 to stop the running timer 308, the time entry database 18 automatically converts the second view 314b into a first view 314a. In an embodiment, the time entry database 18 automatically imports the running timer from a first GUI 350A and/or a second GUI 350B into the second view 314b of the third GUI 350C when the system causes the generation of the third GUI 350C. More specifically, the time entry database 18 determines whether there is an existing running timer 308 and automatically generates a second view 314b for an editable time entry 314 which includes the running timer 308.

At this point, the editable time entries 314 can also be displayed in the first GUI 350A and/or the second GUI 350B as a draft entry. The time entry database 18 automatically populates the day that the time was recorded and the total time and stores these variables in the central memory 22. The user U of the second party P₂ can then enter a client or matter number corresponding to a first party P₁ and/or a narrative into the editable time entry 314 and finalize the editable time entry 314 so that it is displayed as a posted time entry on the first GUI 350A and the second GUI 350B. In an embodiment, the system 10, 110 then uses this information for example to create the real-time graphical illustration 154 shown in FIGS. 4 and 5 for the first party P₁ to access. In an embodiment, the user U selecting a saved running timer 308a in the running timer panel 316 will cause the time entry database 18 to generate a second view 314b of an editable time entry 314 including that saved running timer 308a. In an embodiment, the user U can then continue to record time by selecting that running timer in the second view 314b.

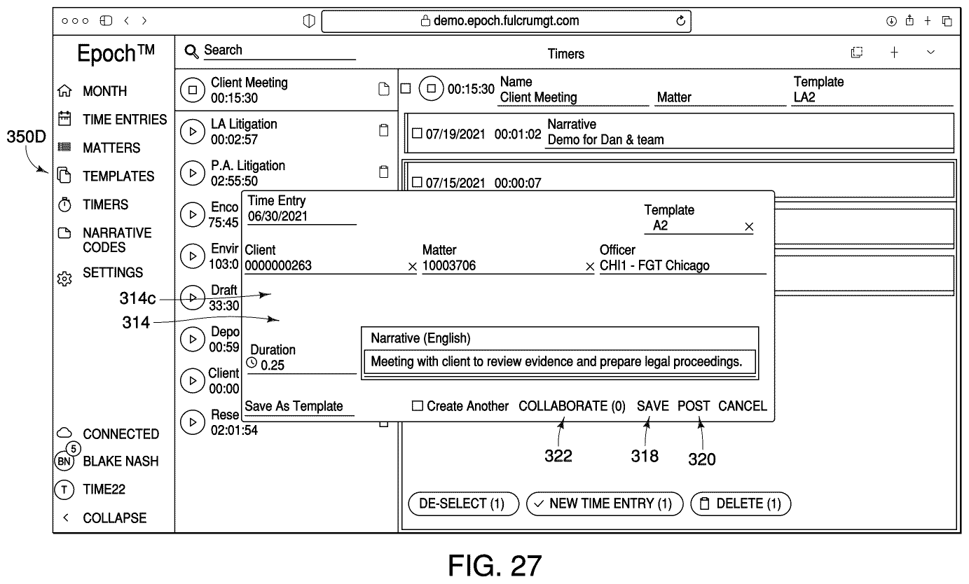

FIG. 27 illustrates an example embodiment of a fourth GUI 350D displayed on a user terminal 14, 15 for a user U in accordance with the present disclosure. The fourth GUI 350D displays a third view 314c of an editable time entry 314. In the third view 314c, the date and duration have been automatically populated by the time entry database 18 based on when the running timer 308 was used by the user U to generate the editable time entry 314. In the illustrated embodiment, the duration is rounded as set by the time entry database 18. In an embodiment, the time entry database 18 sets how the duration is rounded based on the template. The user U can enter various information into the third view 114c, for example, the client number, the matter number, the office, a template and a narrative. When the user U selects the save button 318, the time entry data corresponding to the editable time entry 314 is stored in the central memory 22. When the user U selects the post button 320, the time entry data corresponding to the editable time entry 314 is stored in the central memory 22 and the editable time entry becomes a posted time entry 312 and can no longer be edited. The third view 314c further includes a collaborative function icon 322.

The collaborative function icon 322 triggers streamline processing resources and conserve memory space by using a single editable time entry 114 for multiple timekeepers. In an embodiment, the collaborative function icon 322 causes a single editable time entry 114 to generate editable time entries 114 for multiple timekeepers and/or link corresponding time entry data stored within the central memory 22. In an embodiment, selecting the collaborative function icon 322 causes the generation of a list of a plurality of users U (e.g., other users U who control a user terminals 15). The user U who is currently utilizing the collaborative function is enabled to select one or more additional users U from the list. In an embodiment, the user U selects each additional user U who was involved in a project relating to the editable time entry 114 being linked using the collaborative function. For example, in the illustrated embodiment, the narrative is “Meeting with client to review evidence and prepare legal proceedings.” The user U therefore uses the collaborative function to select each additional user U who was involved in this meeting. On a practical level, this saves time for the additional users U and prevents errors and inconsistencies in work-in-progress reports and/or billing reports by ensuring that the time and/or narrative recorded for each user U in the meeting is the same. On a computer component level, this streamlines computer processing and conserves memory space by using a single editable time entry 114 for multiple timekeepers.

In an embodiment, when a user U uses the collaborative function icon 322, the system 10, 110 updates the real-time graphical illustration 154 shown in FIGS. 4 and 5 for the first party P₁ to access. For example, the system 10, 110, based on the user U selecting the collaborative function icon 322 to indicate multiple people collaborating on a project, updates the real-time graphical illustration 154 shown in FIGS. 4 and 5 with not only the user U's time, but also anticipated time from other users U who collaborated on the project. This was, the graphical illustration 154 can indicate real-time progress even before all users U have input their billed time. The system 10, 110 can then later rectify any differences when all of the users U have input or verified their billed time.

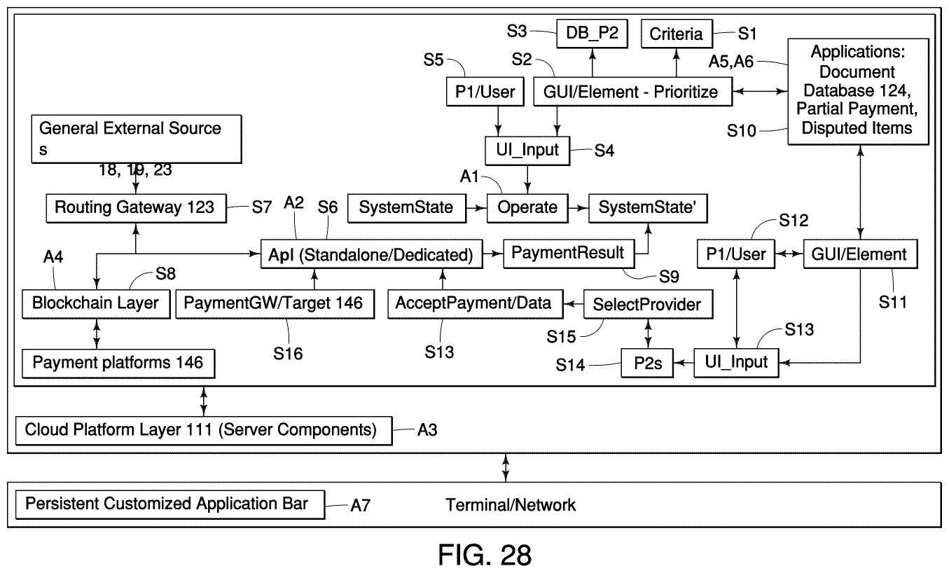

FIGS. 28 to 30 illustrate example embodiments of algorithmic methods that can be used to implement the systems 10, 110 discussed herein, as well as their corresponding user interfaces and methods. Those of ordinary skill in the art will recognize from this disclosure that the disclosed algorithms and corresponding methods are examples only and that other algorithms and methods can be used without departing from the spirit and scope of the present disclosure.

The following abbreviations are used in the algorithms.
P1 refers to a first party (e.g., the party seeking one or more service provider).
P2 refers to a second part or a set of second parties (e.g., potential service providers).
DB_P2 refers to a database of second party P2 information.
DB_Docs refers to the document database 124.
DB_Ext (source) refers to external data from a source (e.g., DB_Ext (Time), DB_Ext (Public)).
GUI ( . . . ) refers to a function generating a GUI based on input data.
UI_Input (User, Element) refers to input received from a first user FU or second user SU via a GUI element.
API (Target, Data) refers to a communication via API 121 or API 122 to a target system with data.
NN refers to a neural network model.
Params refers to a set of parameters (e.g., for bids).
Bids refers to a set of bids received.
Invoice refers to an invoice data structure.
PaymentGW refers to a third-party payment gateway/platform 146.

FIG. 28 illustrates an example embodiment of implementing an ordered series of algorithms to initialize and operate the single platform 111 discussed herein. In an embodiment, an initial algorithm A1 which operates to transform an initial SystemState to an updated System State′ can be characterized as follows:

$$Core System : {SystemState}^{′} = Operate ( SystemState , UI\_Input ( P 1 , GUI ( Prioritize ( DB\_P 2 , Criteria ) ) ) ) PaymentResult = API ( PaymentGW , AcceptPayment ( SelectProvider ( P 2 s , UI\_Input ( P 1 , … ) ) ) )$$

Algorithm A1 initializes the system 10, 110 including the central server 12 having the processor 20 and memory 22 and stores/maintains the second party database 116. More specifically, the system 10,110 is initialized for communication via the network 16 with the user terminals 14 of the first party P1 and the user terminals 15 of the second party P2. The second party database 116 within the single platform 111 (e.g., as part of the central database 26) is also initialized to store and provide profiles, expertise, rates, etc., for multiple second parties P2.

At step S1 during operation of the algorithm A1, the system 10, 110 receives client criteria from the first user FU of the first party P1 using a first user terminal 14. More specifically, the system 10, 110 receives client criteria via the GUI 25 generated on one or more user terminals 14 in accordance with the methods discussed above. For example, the system 10, 110 can receive the client criteria from a first user FU of the first party P1 using the filters 155 on GUI 150B of a user terminal 14 as shown in FIG. 6. In an embodiment, the system 10, 110 receives selection criteria such as expertise and location from a first user FU using a user terminal 14.

At step S2, the system 10, 110 then prioritizes second parties P2. In the illustrated embodiment, the processor 20 queries the database 116 at step S3 based on the entered criteria from step S1. The processor 20 also applies artificial intelligence/neural network scoring logic using data from the public or private sources 19, 23 and internal data as discussed herein. The processor 20 ranks matching second parties P2 as described above. The processor 20 then generates a prioritized GUI 25 (e.g., GUI 150B showing provider list 156 as shown in FIG. 6) displaying the prioritized/ranked second party P2 data within the common application section 151.

At step S4, the system 10, 110 provides the prioritized GUI 25 to the first party P1, and at step S5, the system 10, 110 further enables selection of one or more of the ranked second parties P2 by the first party P1. For example, the system 10, 110 enables a first user FU via the GUI 25 to select a specific second party P2 by clicking on a provider in the list 156.

At step S6, the system 10, 110 further defines the API/gateway. In an embodiment, the system 10, 110 utilizes one or more API(s) (e.g., a standalone API 121 and a dedicated API 122 as discussed above) to define communication via the routing gateway 123 to the external sources (e.g., SAP/non-SAP clients 138/140, the public database 19, the time entry database 18, the quote database 23).

The system 10, 110 then communicates with external sources and populates the GUI 25 with GUI data. More specifically, the processor 20 communicates via the routing gateway 123 at step S7 and the APIs 121,122 to retrieve data (e.g., as a real-time progress from the database 18, public info from the database 19) for rendering elements within GUI 25 (e.g., as seen in the graphical illustration 154 in FIGS. 4 and 5). The system 10, 110 also communicates with a third-party payment gateway/platform 146 including data security functions at step S8. More specifically, the processor 20 communicates via the dedicated API 122 with a third-party payment gateway/platform 146 as discussed above. At step S9, the system 10, 110 further process payment for the provider side, with the processor 20 causing the common application section 151 of GUI 25, 27 to accept payment from the selected service provider (second party P2) using the gateway 146 via the API 122.

As discussed above, the system 10, 110 is configured to structure the API 121, 122 to include a standalone API 121 and the dedicated API 122. An algorithm A2 to implement the dual API architecture to define the API set and conditional usage can be characterized as follows:

$$API Structure : API\_Total = \{ API\_Standalone ( 121 ) , API\_Dedicated ( 122 ) \} Comm ( Target ) = IF Target ∈ \{ SAP , NonSAP \} THEN API\_Standalone ( … ) ELSE IF Target ∈ \{ PaymentGW \} THEN API\_Dedicated ( … )$$

In the illustrated embodiment, the algorithm A2 structures the API layer to include: (1) the standalone API 121 connected to routing gateway 123, which handles communications with general external clients/sources such as SAP S/4 HANA clients 138 and non-SAP clients 140, as shown in FIG. 3; and (2) the dedicated API 122, which is configured to bypass the routing gateway 123 for direct, secure communication with specific external systems like third-party payment platforms 146. Route communication requests (e.g., for GUI data, payment processing) through the appropriate API 121, 122 are based on the target external system.

Using the API 121 and the API 122 in this way offers several advantages, including enhanced flexibility, streamlined workflows, and new revenue opportunities. First parties P1 and second parties P2 can integrate with various systems, automate tasks, and create custom solutions, ultimately improving efficiency and user experience. First parties P1 and second parties P2 can also scale their operations and access pre-built functionalities, saving time and resources. The API 121 and the API 122 automate repetitive tasks and data transfer between systems, freeing up resources and improving overall efficiency, enable seamless integration with external services to enhancing user experience and creating more intuitive applications, and allow for the development of modular and scalable applications.

As discussed above, the system 10, 110 is configured to utilize at least one processor 20 that is part of the remotely accessible cloud platform 111. An algorithm A3 to specify location for cloud platform deployment and remote access configuration can be characterized as follows:

Cloud Platform: Location(Processor(20))=CloudPlatform(111)Access(P1/P2s)=Network(16)

Algorithm A3 structures the system 10, 110 to host the central server components (processor 20, memory 22, databases 26/116, etc.) on the cloud platform 111 accessible remotely by user terminals 14, 15 via network 16, as seen in FIGS. 1 and 3.

As discussed above, the system 10, 110 is configured to utilize a third-party payment gateway/platform 146 such as a third-party blockchain payment gateway at step S8. An algorithm A4 to specify type and integrate the blockchain payment gateway for communication can be characterized as follows:

Blockchain Payment: PaymentGW_Type=BlockchainAPI(PaymentGW_Blockchain, . . . )

Algorithm A4 ensures that the third-party payment gateway/platform 146 is integrated via dedicated API 122 (e.g., at steps S7 to S9 in algorithm A1 above) and utilizes blockchain technology for enhanced security and transparency in payment transactions.

As discussed above, the system 10, 110 is configured to enabling both the first party P1 and the selected second party P2 (e.g., the selected service provider) to edit at least one document in the document database 124 via a common application section 151 of the GUI 25, 27. An algorithm A5 to integrate collaborative document editing with live updates can be characterized as follows:

Document Editing: Edit(Doc∈DB_Docs,User∈{P1,SelectedP2})→DB_Docs' GUI_Section(151)→Provides(Access(DB_Docs))

As discussed above, the system 10, 110 includes a document database 124 within the platform 111. At step S10, the processor 20 executes a document collaboration application accessible via common application section 151 of GUI 25, 27, which enables a first user FU of the first party P1 and a selected user SU of a second party P2 to concurrently access and edit documents (e.g., contracts) within the database 124 via section 151 (e.g., including live editing, commenting, redlining, and version control). With the fifth algorithm A5, upon an edit by one of the first party P1 and the second party P2, the GUI 25, 27 is configured to generate a useable edit icon linking directly to the changes within the document application. The other of the first party P1 and the second party P2 can then select the useable edit icon to further edit the document. In an embodiment, the useable edit icon only appears on the GUI 25, 27 of one party P1, P2 after an edit by the other party P1, P2.

As discussed above, the system 10, 110 is configured to structure the GUI 25, 27 to accept partial payment using the third-party payment gateway 146 while at the same time disputing a portion of the payment. An algorithm A6 to implement GUI-driven partial payment and invoice dispute processing upon implementation can be characterized as follows:

Partial/Disputed Payment:Amount_Paid=FullAmount(Invoice)−DisputedAmount(UI_Input(P1,GUI_Invoice))API(PaymentGW,Pay (Amount_Paid))LogDispute(DisputedAmount( . . . ))

Within the payments application (e.g., as shown on the GUI 150G in FIGS. 16 and 17) displayed in common section 151, a first user FU of a first party P1 can select specific line items or amounts on an invoice. The GUI 25 provides first options (e.g., “Reject” and “Dispute” in FIG. 17) to flag selected items/amounts as disputed at step S11. The GUI 25 also provides second options (e.g., “Release to Pay” and “Approve” in FIG. 17) to initiate payment at step S11. At step S12, the GUI 25 is generated for the first user FU as discussed above. Upon selection at step S13, the processor 20 calculates the non-disputed amount and communicates only this partial payment amount to the third-party payment platform 146 via API 122 at step S11. More specifically, the processor 20 identifies the second party P2 to which the partial payment applies at step S14, selects that second party provider P2 at step S15, and the processor 20 further logs the disputed items/amount for tracking and potential resolution via an integrated dispute center. The API 122 can receive payment via the payment platform 146 at step S16 or via the blockchain layer at step S8 as enabled above.

As discussed above, the system 10, 110 is configured so that the processor 20 is programmed to swap a plurality of functional applications within the common application section 151 based on selections made using the application bar 152. An algorithm A7 to implement dynamic application swapping via application bar navigation upon implementation of the algorithm A7 can be characterized as follows:

GUI Navigation:CurrentApp=RenderApp(SelectedIcon∈AppBar(152))Display(CurrentApp,Section(151))

Algorithm A7 renders the GUI 25, 27 with a persistent application bar 152 containing selectable icons (e.g., Home 152A, Providers 152B, Procure 152C, Listings 152D, Services 152E, Payments 152F in FIG. 4). Algorithm A7 further maintains the common application section 151 below/adjacent to the application bar 152. The processor 20 monitors application bar 152 for user selections. Upon selection of an icon (e.g., 152C), processor 20 retrieves the corresponding application module (e.g., bid creation GUI 150D), clears the previous content of section 151, and renders the new application module's interface and data within section 151.

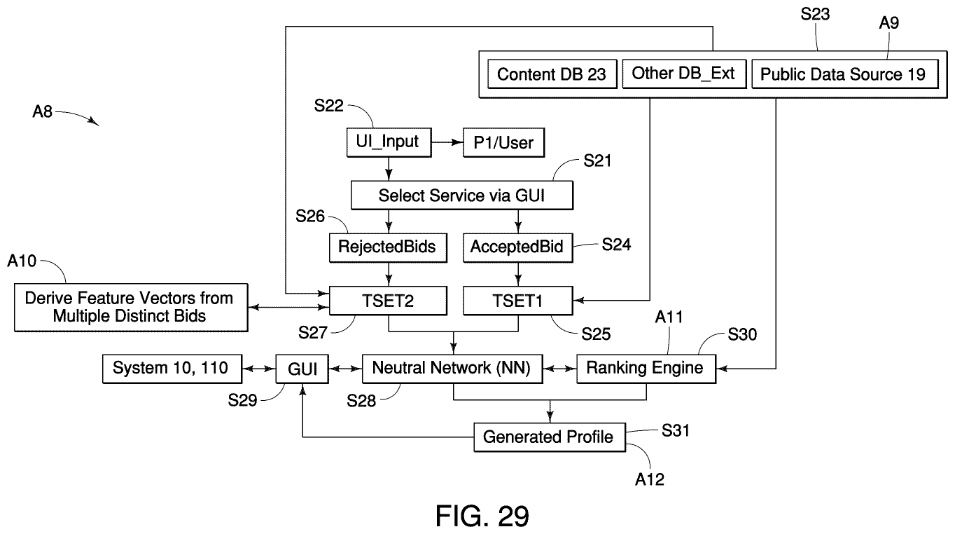

FIG. 29 illustrates an example embodiment of training a neural network to retrieve bids for a service from a plurality of external service providers as discussed above. In an embodiment, an initial algorithm A8 for two-stage neural network training for bid prioritization can be characterized as follows:

NN Training(Bids):AcceptedBid=Select(Bids,UI_Input(P1))RejectedBids=Bids\{AcceptedBid}TSet1={AcceptedBid,DB_Ext(Public,Provider(AcceptedBid))}TSet2={(b,DB_Ext(Public,Provider(b)))|b∈RejectedBids}NN_Trained=Train(Train(NN_Initial,TSet1,Stage1),TSet2,Stage2)

Algorithm A8 sets the operations and training function composition. Initially, the algorithm A8 collects bid data via the platform 111 (e.g., utilizing the auction engine 117). In FIG. 29, the algorithm A8 collects bid details (e.g., price, provider ID, terms, and potentially weighted factors as discussed above) for a service solicited via GUI 150D at step S21. The bid details include all second party details available to the first party P1 via the GUI 25 when the first party P1 selects a bid using the GUI 25 at step S22.

The algorithm A8 then retrieves public data for each bidding second party P2 at step S23. For example, the processor 20 retrieves data (regarding ratings, size, expertise tags, diversity, etc. as discussed above) from one or more public databases 19 and/or content databases 23 via the network 16. At step S24, the algorithm A8 records the acceptance of a first party P1's selection of an accepted bid via GUI 25 (e.g., from listing GUI 150E as shown in FIG. 12) at step S21. At step S25, the processor 20 then create a first training set TSET1 by constructing a dataset containing features from the accepted bid(s) combined with the retrieved public data features for the second party P2 selected by the first party P1 as the service provider. At step S26, the algorithm A8 also records a plurality of rejected bids from step S21. At step S27, the processor 20 creates a second training set TSET2 by constructing a dataset containing features from the rejected bid(s) combined with the retrieved public data features from step S23 for the second parties P2 not selected by the first party P1 as the service provider at step S21. The processor 20 then inputs the first training set TSET1 to a neural network model as a first stage of training, thus training the neural network to recognize patterns associated with successful bids at step S28. The processor 20 also inputs the second training set TSET2 to the neural network as a second stage of training at step S28, thus further training the neural network to differentiate between successful and unsuccessful bid characteristics.

In an embodiment, the system 10, 110 is configured to enhance bid prioritization by integrating one or more language learning models (LLMs) to improve feature extraction and contextual understanding. More specifically, the system 10, 110 is configured to integrate one or more LLMs for textual feature extraction, and thus use an LLM to generate natural language descriptions of bids based on numerical features (e.g., bid amount, the first party P1 criteria, and provider attributes) at step S29. An example sample prompt can be characterized as: “Generate a detailed textual description of a bid with the following parameters: bid amount=$500 M, first party P1 criteria=meeting deadline and budget constraints, provider attributes=high expertise in construction services.” The LLM is configured to then output a coherent text sequence describing the bid in a way that enhances model interpretability.

In an embodiment, the system 10, 110 is configured to utilize a retrieval augmented generation (RAG) for contextual retrieval. The system 10, 110 uses retrieval augmented generation to augment the neural network with a RAG system to retrieve relevant historical data from the database. The system 10, 110 uses prompts to query specific aspects of the first party P1's criteria or provider attributes. An example sample prompt can be characterized as: “Retrieve all bids from the last 30 days where Provider expertise matches ‘Construction Services’ and budget aligns with P1's request.” The system 10, 110 estimates use of about 50 tokens per description using NLP but estimates use of RAG prompts and queries would lower the token use to 20-30 per query, thus reducing processing from about 40-60% by converting to RAG prompts. The less tokens an action takes, the more processor power is available for other tasks. Accordingly, using the estimated textual features versus RAG prompts requires on average more tokens. Thus, configuring the system 10, 110 to utilize RAG in actions improves technological efficiency, increased processor efficiency, and increased computer data storage management.

The system 10, 110 is further configured to utilize flow logic to preprocess numerical bids into textual descriptions using the LLMs. For example, the system 10, 110 is configured to use RAG retrieval to retrieve relevant historical data based on a first party P1's criteria and provider attributes. The system 10, 110 is further configured to integrate retrieved information with neural network inputs and prompts for enhanced bid prioritization accuracy.

The system 10, 110 is also configured to utilize the one or more public data sources such as a third party database accessible via a public website as part of the neural network training. An algorithm A9 to specify source inclusion to implement public website database retrieval for neural network training data can be characterized as follows:

Public Data Source: DB_Ext(Public)⊇Access(Website_DB)

Algorithm A9 ensures that the system 10, 110 accesses the third-party database 19, which is hosted externally and accessible via network 16, through a public website interface or API as discussed above.

As discussed above, the system 10, 110 is further configured to utilize neural network training set data from multiple bids that were not accepted. The system (10) can use this data to calculate the likelihood of success for new bids under a pre-determined or custom algorithm. An algorithm A10 to implement a cardinality constraint for multiple rejected bid data compilation for the neural network training set can be characterized as follows:

Second Training Set: |{b|b∈RejectedBids}|>1 TSet2 uses data from multiple elements of RejectedBids.

Algorithm A10 ensures that the second training set TSET2 (from step S25) includes feature vectors derived from multiple distinct bids that were submitted for the service but ultimately not selected by the first party P1. The feature vectors are represented as vectors in a high-dimensional space, allowing the model to capture complex relationships between different data points. The system 10, 110 uses the feature vectors to represent the data in a numerical format and translate the bids into a numerical score. The numerical score can then be used to rank the bids. The system 10, 110 is configured to use the score to rank the bids at step S29. The feature vectors represent the semantic meaning and relationships between words, sentences, images, etc. In image recognition, a feature vector can be used to capture the key characteristics of an image, such as the intensity of red, green, and blue pixels (RGB), or the presence and location of edges, corners, or specific shapes—basically code a number or unique code to an image to describe the image. An example of feature vectors used in the current embodiment would be to use feature vectors to capture and represent bids, whether successful or unsuccessful and for a given customer or vendor or relationship. The numerical representations can also be referred to as embeddings and capture the underlying meaning and context of the input data. The feature vectors can be used to measure bid parts such geographic region, rates, availability, level of experience, etc.

In an embodiment, the system 10, 110 is configured to derive feature vectors from one or more accepted bids and one or more rejected bids. The system 10, 110 is configured to use the feature vectors to represent the data in a numerical format and translate the bids into a numerical score. The system 10, 110 is configured to train the neural network so that the accepted bids receive a higher score than the rejected bids. In an embodiment, the output data used to train the neural network includes scores used for rankings, with the training scores for the bids accepted by the first party greater than the training cores from the bids rejected by the second party, leading to subsequent output of scores by the neural network that score future bids higher when they are more likely to be accepted by the first party, enabling the bids to be ranked or arranged accordingly on the graphical user interface. In an embodiment, the system 10, 110 revises listings of bids for existing matters using the trained neural network to rescore or otherwise rerank the existing bids.

In an embodiment, the system 10, 110 converts each accepted and rejected bid into a feature vector that represents a relative attribute. The geographic region can be represented as a one-hot encoding or learned embedding. The rate can be represented as a normalized numeric value. The availability can be represented as a numeric availability score or time-based encoding (e.g., availability hours). The practice specialty can be represented as a one-hot or multi-hot encoding (if multiple specialties) or embedding. The system can the provide explicit and implicit labels. An example explicit label is bid A ranked higher than bid B for a given task. An example implicit label is bids that were selected versus rejected. From this information, the system 10, 110 can create training pairs. For example, a training pair can be bid A>bid B. Another example is to listwise rank multiple bids for the same task as described herein. The system 10, 110 can then use the feature vectors as model inputs and the score as the output. For pairwise training, the system 10, 110 can train the neural network (e.g., an MLP) to train on pairs and learn to assign higher scores to better bids more likely to be accepted. For listwise training, the system 10, 110 can train the neural network on ordered lists of bids. The system 10, 110 can train the neural network to assign scores such that the rank order of the bids reflects the training data.

In an embodiment, the system 10, 110 is configured to train a Large Language Model (LLM) using the feature vectors, with the feature vectors representing data in a numerical format that the LM can process, allowing the LLM to analyze and generate text. The trained LLM can then use additional feature vectors to perform similarity searches, identifying similar pieces of data based on their numerical representations. The trained LLM can also be used to generate second party listings or propose edits to existing second party listings.

In an embodiment, the system 10, 110 uses the weights input by the first party during the bid creation process to train the neural network (e.g., as seen in GUI 150D in FIG. 10). For example, the system 10, 110 can weight the neural network training date as identified by the user so that feature vectors related to higher weights are given higher overall importance to the final score or ranking in comparison to feature vectors related to lower weights. This way, the neural network is trained to know specific features regarded by the first party P1 as important for the acceptance or rejection of bids, allowing the neural network to customizes the scores or rankings for the first party P1 and/or determine specific changes to rejected bids that would make the bid more likely to be accepted by the first party P1. The system 10, 110 can thus use the weights entered by the user for multiple purposes including bids for a particular service and neural network training for subsequent bids on another service.

The system 10, 110 is configured to train the neural network to match first parties P1 with a plurality of second parties P2 based on various parameters such expertise, location, and user preference at step S28. An algorithm A11 to implement neural network client-provider matching and ranking engine at step S30 can be characterized as follows:

NN App(Matching):Rank(P2s)=NN_Trained_Match(Criteria_P1,DB_P2,

DB_Ext (Public)) GUI ( . . . ). The ranking engine can also be tuned to constrain bidder responses based on the bidder response data and bidder response history and relationship between the parties.

Algorithm A11 causes the GUI 25 to display second parties P2 ordered by a rank output by the neural network at step S30. More specifically, algorithm A11 configures the training objective to specifically learn mappings between second party P2 attributes (e.g., expertise, location from database(s) 116, 19 and first party P1 needs/preferences inferred from bid history or explicit first party P1 inputs). The system 10, 110 then implements a post-training feature. For example, when a first party P1 uses the second party P2 provider search (e.g., GUI 150B), the processor 20 uses the trained neural network to score or rank providers in list 156 based on predicted suitability for the first party P1's specific needs as discussed above.

In an embodiment, the system 10, 110 enhances provider matching by integrating the LLMs to improve feature richness and contextual understanding. More specifically, the system 10, 110 integrates and uses LLMs to generate natural language descriptions of client needs and provider attributes. An example prompt can be characterized as

Input: “Summarize the following client need and provider attributes in a coherent text sequence: Client Need=‘Reduce lead time’, Provider Attributes=‘High expertise in project management’.”
Output: A concise text sequence that highlights the key aspects for matching.

The system 10, 110 then uses RAG for contextual retrieval. That is, the system 10, 110 augments the neural network with a RAG system to retrieve relevant historical interactions or patterns. A sample prompts to guide the retrieval process can be characterized as: “Identify potential matches where provider expertise aligns with P1's current project and has previously matched on ‘lead time reduction’.” The system 10, 110 estimates use of about 40 tokens per description using NLP but estimates use of RAG prompts and queries would lower the token use to 25-35, thus reducing processing from about 12-37% by converting to RAG prompts. As discussed above, the less tokens an action takes, the more processor power is available for other tasks, meaning that configuring the system 10, 110 to utilize RAG in actions improves technological efficiency.

The system 10, 110 is configured to further utilize logical flow to preprocess provider attributes and client needs into textual descriptions using LLMs. The system 10, 110 is configured to use RAG to retrieve historical matching patterns or relevant data points based on the processed text. The system 10, 110 is further configured to integrate retrieved information with neural network inputs for enhanced compatibility scoring accuracy.

At step S28, the system 10, 110 is also configured to train the neural network to generate a profile of an external service provider that can then be customized by the external service provider. An algorithm A12 which utilizes a neural network provider profile auto-generation and customization workflow can be characterized as follows:

NN App(Profile Gen):Profile_Draft=NN_Trained_Profile(ProviderID,DB_Ext(Public))Profile_Final=Customize(Profile_Draft,UI_Input(Provider,GUI_Profile))DB_P2′=Update(DB_P2,Profile_Final)

The algorithm A12 trains the neural network using public data (e.g., from database 19) and optionally existing provider data (e.g., from the database 116) to learn profile structures. The system 10, 110 then implements a post-training feature at step S31. For example, the processor 20 uses the trained neural network to aggregate data and generate a draft profile for a specific provider P2. The processor 20 then renders the draft profile in GUI 150C (e.g., accessed via GUI 150B) at step S29. The system 10, 110 further enables the second party P2 to edit/customize fields within GUI 150C and then stores the customized profile data in the second party database 116 as discussed above. The system 10 110 is also configured to use these customizations to refine future training sets TSET1, TSET2.

The system 10, 110 is further configured to enhance second party P2 provider profile generation by integrating LLMs to improve feature diversity and contextual relevance at step S29. The system 10, 110 integrates LLMs using an LLM-driven profile summarization using an LLM to generate natural language summaries of provider profiles based on DB_P2 data. An example prompt can be characterized as:
Input: “Summarize the following provider profile in a coherent text sequence: Provider Name=‘Construction Services’, Expertise=‘Construction’, Specialization=‘High-rise construction’, Years of Experience=10, Previous Projects=‘Multiple high-profile construction projects’.”
Output: A concise and descriptive text summary that highlights key provider attributes.

The system 10, 110 is further configured to use RAG for contextual enhancement at step S28. That is, the system 10, 110 is configured to augment the neural network with a RAG system to enhance feature inputs based on context using prompts to guide the integration of external data. An example prompt can be characterized as: “Enhance the following profile input with additional contextual information about P2's expertise in ‘Construction Services’: Profile Input=‘Provider Name, Expertise, Specialization’.” The system 10, 110 estimates use of about 50-60 tokens per description using NLP but estimates use of RAG prompts and queries would lower the token use to 35-45, thus reducing processing from about 10-42% by converting to RAG prompts. As discussed above, the less tokens an action takes, the more processor power is available for other tasks, meaning that configuring the system 10, 110 to utilize RAG in actions improves technological efficiency.

As discussed above, the system 10, 110 is configured to preprocess provider data into textual summaries using LLMs and use RAG to enhance profile inputs with contextual information (e.g., a third party P2's expertise, past projects). The system 10, 110 is further configured to integrate enhanced feature inputs with neural network for improved profile generation accuracy.

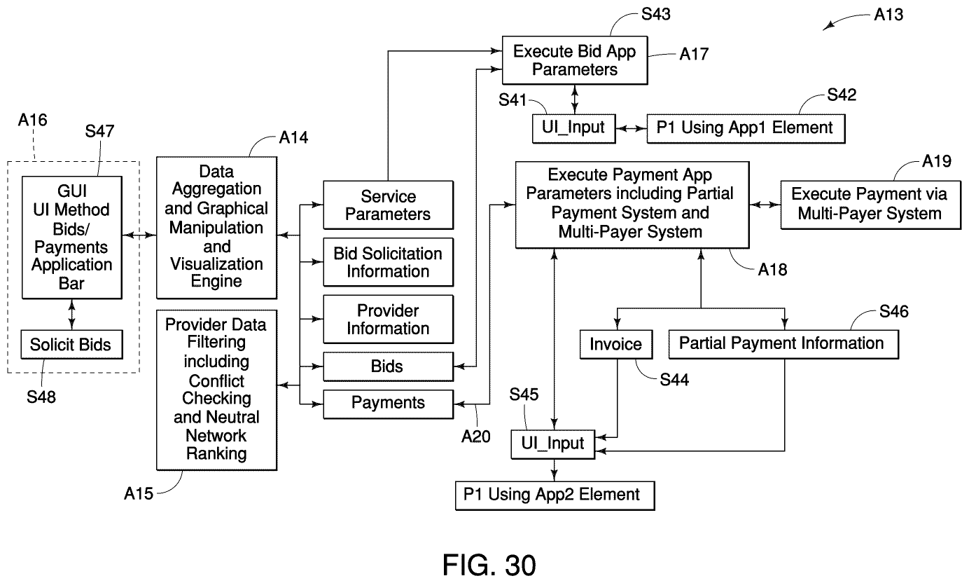

FIG. 30 illustrates an example embodiment of an algorithm to retrieve bids for a service from a plurality of external service providers as discussed above. In an embodiment, an initial algorithm A13 for integrated user interface workflow from bid solicitation to partial payment execution can be characterized as follows:

UI Method(Bids/Payments):Bids=ExecuteBidApp(GenerateParams(UI_Input(P1,App1)))PaymentResult=ExecutePaymentApp(Invoice,PartialReject(UI_Input(P1,App2)))

Algorithm 30 provides the GUI 25 to the first party P1 at step S41, with the GUI 25 including the application bar 152 and common application section 151 as discussed above. A first user FU of the first party P1 then selects the procure services icon 152C on the application bar 152. The processor 20 renders a bid creation application (e.g., as shown in GUI 150D) within the common application section 151 as discussed above. At step S42, the first user FU inputs service parameters (e.g., start/end dates, law area, region, adverse parties, budget, weights, etc.) via GUI 150D as seen for example in FIGS. 8 to 10. The first user FU also assigns providers via the toggle 164 as shown in FIG. 11. At step S43, the processor 20 executes bid solicitation, for example by publishing the parameters/listing via auction engine 117 or directly, and then receives bids into the platform 111. The first user FU can also select the payments icon 152F on the application bar 152. The processor 20 renders the payments application (e.g., as shown in GUI 150G) in the common application section 151. The first user FU can also select an invoice 170 (e.g., as shown in FIG. 15) at step S44 using the GUI at step S45, view details (e.g., as shown in FIG. 16), and use other options (e.g., as shown in FIG. 17) to mark a portion for rejection/dispute as discussed above. The processor 20 also executes partial payment by calculating an undisputed amount and initiating a transaction via the API 122 to payment platform 146 at step S46.

The system 10, 110 is configured to enable at least one first application to cause retrieved third party data to be combined with local data and generate a graphical illustration illustrating the data in the common application section 151. An algorithm A14 to cross-source data aggregation and graphical visualization engine can be characterized as follows:

Data Viz:VizData=Combine(DB_Ext(Time),LocalData(Budget))GUI_Section(151)displays RenderChart(VizData)

With algorithm A14, when user accesses a home screen (e.g., icon 152A on GUI 150A) or another relevant matter view, the processor 20 retrieves time/cost data from external time entry database 18 via an API/gateway as discussed above, retrieves corresponding budget data (e.g., from accepted bid) stored locally in the memory 22/database 26 as discussed above, combines actual time/cost with projected budget, generates a graphical illustration 154 (e.g., budget vs. actual chart as seen in FIG. 5), and renders illustration 154 within common application section 151 of GUI 150A as discussed above.

The system 10, 110 is also configured so that at least one application enables the user to adjust filters to identify criteria for the service. An algorithm A15 for dynamic provider filtering and neural network-ranked listing upon implementation of the algorithm A15 can be characterized as follows:

Filtering:Filtered_P2s=Filter(DB_P2,UI_Input(P1,Filters(155)))Ranked_Filtered_P2s=NN_Trained_Match(Criteria_P1,Filtered_P2s)GUI( . . . )displays Ranked_Filtered_P2s

Algorithm A15 implements filtering followed by ranking as discussed above. With algorithm A15, when a first user FU selects the providers icon 152B on the common application bar 152, the processor 20 renders the provider search application (e.g., GUI 150B) in the common application section 151 as discussed above. The GUI 150B is configured to present filter controls 155 for criteria such as rating, location (e.g., distance/geography), practice area, diversity/equity/inclusion rating, engagement type, and other factors, as shown for example in FIG. 6. The system 10, 110 enables a first user FU to interact with controls 155 to set desired criteria. The processor 20 further queries database 116 using the filter criteria, uses a trained neural network (e.g., as with algorithm A11) to rank results, and updates the provider list 156 displayed in the common application section 151.

The system 10, 110 is also configured so that at least one first application generates a listing to solicit bids for the service. An algorithm A16 to generate and distribute automated bid solicitation listings can be characterized as follows:

Listing Gen:Listing=CreateListing(Params(UI_Input(P1, . . . )))Publish(Listing,TargetProviders)

With algorithm A16, as the first user FU inputs parameters via the GUI 150D (Step S42), the processor 20 populates a data structure representing the bid solicitation listing. Upon user confirmation (e.g., after completing steps in FIG. 29), the processor 20 finalizes the listing data structure at step S47. The processor 20 then transmits this listing to the auction engine 117 (if applicable) or directly to the network interfaces of the assigned providers P2 (e.g., selected via FIG. 11) to solicit bids at step S48.

The system 10, 110 is also configured so that at least one first application (App1) enables the user to indicate at least one of a start date for the service, an end date for the service, an area of law for the service, a region of the service, and any adverse parties involved in the service. An algorithm A17 that captures detailed service parameters for bid listings and conflict checks can be characterized as follows:

Parameters:Params⊇{StartDate,EndDate,LawArea,Region,AdverseParties}Params=Capture(UI_Input(P1,GUI(150D)))

Algorithm A17 ensures that the GUI (e.g., GUI 150D in FIG. 8) provides distinct input fields enabling the first users FU of the first party P1 to specify and store: (1) matter start date MS, (2) matter end sate ME, (3) practice areas, (4) region(s)/state(s) of service, (5) adverse party name(s) (e.g., conflict checks). The processor 20 stores these inputs within the platform 111, associated with the generated listing (e.g., with algorithm A16 discussed above).

The system 10, 110 is further configured so that at least one second application includes a payments application that can be executed to perform a full or partial payment of the invoice. An algorithm A18 for a full and partial processing of a configurable payments application can be characterized as follows:

Payment App Full/Partial:PaymentApp(Invoice,Action)→API(PaymentGW,Pay(Amount))Amount=IF Action=‘PayFull’THEN FullAmount ELSE IF Action=‘PayPartial’THEN PartialAmount

With algorithm A18, the second application (App2), accessed via icon 152F and rendered as GUI 150G, functions as the payments application as described above. The GUI (e.g., GUI 150G shown in FIG. 17) provides explicit user actions (e.g., “Approve,” “Release to Pay,” “Reject,” “Dispute”) at step S46. By selecting “Approve”/“Release to Pay” without disputes triggers the processor 20 to initiate full payment via the platform 146. Selecting “Reject”/“Dispute” logic (as per algorithm A6 discussed above) triggers the processor 20 to initiate partial payment of the undisputed amount via the platform 146.

The system 10, 110 is also configured so that at least one second application includes a payments application that can be executed to enable multiple parties to pay the invoice. An algorithm A19 for allocating and executing a multi-party payer and invoice function can be characterized as follows:

Payment App Multi-Party: TotalAmount=ΣAmount(Party_i) where Party_i∈MultiPayers(P1)Allocate(Invoice,{Party_i},{Amount_i})∀i: API(PaymentGW,Pay(Amount_i,Party_i))

Algorithm A19 extends the payments application (e., as shown in GUI 150G) to include features allowing (1) identification/selection of multiple paying entities within the first party P₁ organization (e.g., different cost centers, subsidiaries 142a-n), (2) allocation of invoice amounts/percentages to these entities, and (3) initiation of potentially multiple payment transactions via platform 146 based on these allocations.

The system 10, 110 is also configured so that at least one second application utilizes a third-party payment gateway operatively connected to an application programming interface to execute the partial payment. An algorithm A20 for allocating and executing a dedicated API communication protocol for a partial payment function can be characterized as follows:

Gateway for Partial Payment:ExecutePartialPayment( . . . )→API_Dedicated(122)(PaymentGW,PartialAmount)

With algorithm 20, when the processor 20 executes the partial payment (e.g., triggered by user action in GUI 150G, (at step S45), the processor 20 establishes communication with the designated third-party payment platform 146, which communication occurs specifically via the dedicated API 122 to potentially traversing the firewall 126, and the processor 20 transmits instructions via the API 122 specifying the exact partial amount, recipient (second party P2), and other necessary transaction details to platform 146.

The systems and methods described herein are advantageous, for example, because they create and implement a single full-service platform that increases reliability of quotes for work, optimizes processing resources when generating the quotes and invoicing resulting services, conserves memory space by eliminating data redundancies, and improves the user experience on both the client side and the service provider side. It should be understood that various changes and modifications to the methods described herein will be apparent to those skilled in the art and can be made without diminishing the intended advantages.

### General Interpretation of Terms

In understanding the scope of the present invention, the term “comprising” and its derivatives, as used herein, are intended to be open ended terms that specify the presence of the stated features, elements, components, groups, and/or steps, but do not exclude the presence of other unstated features, elements, components, groups, integers and/or steps. The foregoing also applies to words having similar meanings such as the terms, “including”, “having” and their derivatives. Also, the terms “part,” “section,” or “element” when used in the singular can have the dual meaning of a single part or a plurality of parts. Accordingly, these terms, as utilized to describe the present invention should be interpreted relative to a connecting device.

The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A computer-implemented system linking a first party with a plurality of second parties via a single platform configured to execute multiple applications, the system comprising:
at least one memory storing a second party database including information about the plurality of second parties;
at least one processor programmed to cause generation of a graphical user interface prioritizing data from the second party database based on at least one selection made by the first party, and to enable the first party to select at least one of the second parties as a service provider using the graphical user interface;
an application programming interface configured to define how the at least one processor communicates with a plurality of external sources via a routing gateway; and
the at least one processor programmed to communicate with the plurality of external sources via the routing gateway for generation of the graphical user interface, and to communicate with a third-party payment gateway via the application programming interface to cause a common application section of the graphical user interface to accept payment from the selected service provider using the third-party payment gateway.

2. The system of claim 1, wherein
the application programming interface includes a standalone application programming interface and a dedicated application programming interface.

3. The system of claim 1, wherein
the at least one processor is part of a remotely accessible cloud platform.

4. The system of claim 1, wherein
the third-party payment gateway includes a third-party blockchain payment gateway.

5. The system of claim 1, comprising
a documents database including a plurality of documents,
the at least one processor enabling both the first party and the selected service provider to edit at least one document in the document database via a common application section of the graphical user interface.

6. The system of claim 1, wherein
the graphical user interface is configured to accept partial payment using the third-party payment gateway while at the same time disputing a portion of the payment.

7. The system of claim 1, wherein
the graphical user interface includes an application bar, and
the at least one processor is programmed to swap a plurality of functional applications within the common application section based on selections made using the application bar.

8. A computer-implemented method for linking a first party with a plurality of second parties via a single platform configured to execute multiple applications, the system comprising:
accessing at least one memory storing a second party database including information about the plurality of second parties;
defining communication between a plurality of external sources via a routing gateway;
communicating with the plurality of external sources via the routing gateway for generation of a graphical user interface;
causing generation of the graphical user interface prioritizing data from the second party database based on at least one selection made by the first party;
enabling the first party to select at least one of the second parties as a service provider using the graphical user interface; and
communicating with a third-party payment gateway via an application programming interface to cause a common application section of the graphical user interface to accept payment from the selected service provider using a third-party payment gateway.

9. The method of claim 8, wherein
defining communication with the plurality of external sources via the routing gateway includes establishing a standalone application programming interface and a dedicated application programming interface.

10. The method of claim 8, comprising
enabling both the first party and the selected service provider to edit at least one document in the document database via the common application section of the graphical user interface.

11. The method of claim 8, comprising
swapping a plurality of functional applications within the common application section based on selections made using an application bar.

12. The method of claim 8, comprising
integrating one or more neural network including a language learning model to extract bid features using contextual understanding and generate natural language descriptions based on numerical features.

13. The method of claim 12, comprising
augmenting the neural network using a retrieval augmented generation system to retrieve relevant historical data.

14. A computer-implemented method for linking a first party with a plurality of second parties via a single platform configured to execute multiple applications, the system comprising:
enabling the first party to invite the plurality of second parties to bid on a matter;
causing generation of one or more useable icons on second graphical user interfaces of second user terminals used by the plurality of second parties;
accessing at least one memory storing a second party database including information about the plurality of second parties which accepted the invitation to bid;
generating a first graphical user interface on a first user terminal used by the first party which prioritizes data from the second party database based on at least one selection made by the first party;
enabling the first party to select at least one of the second parties as a service provider using the first graphical user interface prioritizing the data from the second party database; and
enabling the first party to pay a selected service provider for an invoice for the matter via the first graphical user interface using a third-party payment gateway.

15. The method of claim 14, comprising
enabling both the first party and the selected service provider to edit at least one document in the document database via common application sections of the first graphical user interface and the second graphical user interface.

16. The method of claim 15, comprising
swapping a plurality of functional applications within the common application section based on selections made using an application bar.

17. The method of claim 14, wherein
enabling the first party to pay a selected service provider includes configuring the first graphical user interface to accept partial payment using the third-party payment gateway while at the same time disputing a portion of the payment.

18. The method of claim 14, comprising
integrating one or more neural network including a language learning model to extract bid features using contextual understanding and generate natural language descriptions based on numerical features.

19. The method of claim 18, comprising
augmenting the neural network using a retrieval augmented generation system to retrieve relevant historical data.

20. The method of claim 15, wherein
communicating with the third-party payment gateway via an application programming interface to cause a common application section of the first graphical user interface to accept payment from the selected service provider using a third-party payment gateway.
